(19) United States
(12) Patent Application Publication
(10) Pub. No.: US 2018/0199304 A1
(43) Pub. Date: Jul. 12, 2018

(54) SMALL CELL IDENTIFICATION AND ASSISTANT DATA GENERATION FOR MOBILE POSITIONING

(71) Applicant: QUALCOMM Incorporated, San Diego, CA (US)

(72) Inventors: Bruce Wilson, Palo Alto, CA (US); Weihua Gao, San Jose, CA (US); Sai Pradeep Venkatraman, Santa Clara, CA (US)

(21) Appl. No.: 15/404,019

(22) Filed: Jan. 11, 2017

(51) Int. Cl. H04W 64/00; H04B 17/318; H04W 4/02

(52) U.S. Cl. CPC H04W 64/003; H04W 4/02; H04B 17/318

(57) ABSTRACT

Disclosed herein are methods, systems, and apparatuses for identifying a small cell in a wireless communication network. In one embodiment, a method includes receiving information associated with one or more base stations, where the information includes one or more codes associated with the one or more base stations. The method further includes determining whether a code from the one or more codes is associated with a small cell based on, for example, a number of base stations associated with the code; an aggregated area of coverage of the base stations associated with the code; signal strength information of a signal received by a mobile device from a base station of the one or more base stations; information indicating a distance or a data throughput between the mobile device and the base station; or an area of coverage of a base station associated with the code.

### BACKGROUND

A wireless communication network may include multiple macro cells and small cells. Location information of the macro cells and small cells in the wireless communication network may be used as assistance data by mobile devices in various applications. For example, the locations of the macro cells and small cells may allow a location-based service to determine the location of a mobile device.

### BRIEF SUMMARY

Some example techniques are presented herein which may be implemented in various methods and apparatuses in mobile devices or servers to provide for or otherwise support location determination in mobile devices, access points, or base transceiver stations. More specifically, disclosed herein are techniques for identifying small cells and using information regarding the identified small cells for mobile device positioning.

In accordance with an example implementation, a method for identifying small cells may be provided. The method may include receiving information associated with one or more base stations, wherein the information associated with the one or more base stations includes one or more codes associated with the one or more base stations. The method further includes determining whether a code from the one or more codes is associated with a small cell based on at least one of (1) a number of the one or more base stations associated with the code; (2) an aggregated area of coverage of the one or more base stations associated with the code; (3) both (a) a signal strength information of a signal received by a mobile device from a base station of the one or more base stations, where the base station is associated with the code, and (b) information indicating a distance between the mobile device and the base station; (4) the signal strength information of the signal received by the mobile device from the base station of the one or more base stations and information indicating a data throughput between the mobile device and the base station; (5) a first number of base stations associated with the code in a first area, and a second number of base stations associated with a second code in a second area, where the first area and the second area are separated by a distance less than a threshold separation value; or (6) an area of coverage of a base station of the one or more base stations associated with the code. In some embodiments, determining whether a code from the one or more codes is associated with the small cell is based on one or more techniques selected from the group consisting of (1) to (6).

In some embodiments, determining whether the code from the one or more codes is associated with the small cell is at least based on the number of the one or more base stations associated with the code, where the number of the one or more base stations associated with the code is greater than, for example, one thousand (1,000).

In some embodiments, determining whether the code is associated with the small cell is at least based on the aggregated area of coverage of the one or more base stations associated with the code, where the aggregated area of coverage of the one or more base stations associated with the code is greater than, for example, one thousand (1,000) square kilometers.

In some embodiments, determining whether the code is associated with the small cell is at least based on both the signal strength information of the signal and the information indicating the distance between the mobile device and the base station, where the signal strength information includes a received signal strength indicator (RSSI), and the information indicating the distance between the mobile device and the base station includes at least one of a time of flight (TOF), a time of arrival (TOA), or a round trip time (RTT) of the signal. In some embodiments, determining whether the code is associated with the small cell is at least based on both the signal strength information of the signal and the information indicating the distance between the mobile device and the base station, and where the RSSI is below a threshold power level and the distance between the mobile device and the base station is less than a threshold distance value.

In some embodiments, determining whether the code is associated with the small cell is at least based on the signal strength information of the signal received by the mobile device from the base station and the information indicating the data throughput between the mobile device and the base station, where the signal strength information indicates a signal strength below a threshold power level and the data throughput is greater than a threshold data rate value.

In some embodiments, determining whether the code is associated with the small cell is at least based on the first number of base stations associated with the code in the first area and the second number of base stations associated with the second code in the second area, where the first number is one and the second number is greater than one. In some embodiments, the threshold separation value is 100 meters.

In some embodiments, determining whether the code is associated with the small cell is at least based on the area of coverage of the base station of the one or more base stations associated with the code, where the area of coverage of the base station is less than, for example, one square kilometer.

In some embodiments, the method further includes, based on determining that the code is associated with the small cell, sending assistance data to a wireless device, where data associated with base stations associated with the code is excluded from the assistance data to be sent to the wireless device. In some embodiments, the method further includes, based on determining that the code is associated with the small cell, determining that a location of a second mobile device in communication with a second base station associated with the code is a location of the second base station.

In accordance with another example implementation, a system may be provided, which may include a memory comprising machine-readable instructions stored thereon, and a processing unit communicatively coupled to the memory and configured to execute the machine-readable instructions to identify a small cell. The processing unit may execute the machine-readable instructions to receive information associated with one or more base stations, where the information associated with the one or more base stations includes one or more codes associated with the one or more base stations. The processing unit may execute the machine-readable instructions to determine whether a code from the one or more codes is associated with a small cell based on at least one of (1) a number of the one or more base stations associated with the code; (2) an aggregated area of coverage of the one or more base stations associated with the code; (3) both (a) a signal strength information of a signal received by a mobile device from a base station of the one or more base stations, where the base station is associated with the code, and (b) information indicating a distance between the mobile device and the base station; (4) the signal strength information of the signal received by the mobile device from the base station of the one or more base stations and information indicating a data throughput between the mobile device and the base station; (5) a first number of base stations associated with the code in a first area, and a second number of base stations associated with a second code in a second area, where the first area and the second area are separated by a distance less than a threshold separation value; or (6) an area of coverage of a base station of the one or more base stations associated with the code. In some embodiments, determining whether a code from the one or more codes is associated with the small cell is based on one or more techniques selected from the group consisting of (1) to (6).

In some embodiments of the system, determining whether the code is associated with the small cell is at least based on the number of the one or more base stations associated with the code, where the number of the one or more base stations associated with the code is greater than, for example, one thousand (1,000).

In some embodiments of the system, determining whether the code is associated with the small cell is at least based on the aggregated area of coverage of the one or more base stations associated with the code, where the aggregated area of coverage of the one or more base stations associated with the code is greater than, for example, one thousand (1,000) square kilometers.

In some embodiments of the system, determining whether the code is associated with the small cell is at least based on both the signal strength information of the signal and the information indicating the distance between the mobile device and the base station, where the signal strength information of the signal indicates a signal strength below a threshold power level and the distance between the mobile device and the base station is less than a threshold distance value. In some embodiments, the signal strength information includes a received signal strength indicator (RSSI), and the information indicating the distance between the mobile device and the base station includes at least one of a time of flight (TOF), a time of arrival (TOA), or a round trip time (RTT) of the signal.

In some embodiments of the system, determining whether the code is associated with the small cell is at least based on the signal strength information of the signal received by the mobile device from the base station and the information indicating the data throughput between the mobile device and the base station, wherein the signal strength information indicates a signal strength below a threshold power level and the data throughput is greater than a threshold data rate value.

In some embodiments of the system, determining whether the code is associated with the small cell is at least based on the first number of base stations associated with the code in the first area and the second number of base stations associated with the second code in the second area, wherein the first number is one and the second number is greater than one.

In some embodiments of the system, determining whether the code is associated with the small cell is at least based on the area of coverage of the base station of the one or more base stations associated with the code, and wherein the area of coverage of the base station is less than, for example, one square kilometer.

In some embodiments of the system, the processing unit is further configured to execute the machine-readable instructions to, based on determining that the code is associated with the small cell, send assistance data to a wireless device, wherein data associated with base stations associated with the code is excluded from the assistance data to be sent to the wireless device. In some embodiments of the system, the processing unit is further configured to execute the machine-readable instructions to, based on determining that the code is associated with the small cell, determine that a location of a second mobile device in communication with a second base station associated with the code is a location of the second base station.

In accordance with yet another example implementation, a non-transitory computer-readable storage medium including machine-readable instructions stored thereon may be provided. The instructions, when executed by one or more processing units, may cause the one or more processing units to identify a small cell by receiving information associated with one or more base stations, where the information associated with the one or more base stations includes one or more codes associated with the one or more base stations; and determining whether a code from the one or more codes is associated with the small cell based on at least one of (1) a number of the one or more base stations associated with the code; (2) an aggregated area of coverage of the one or more base stations associated with the code; (3) both (a) a signal strength information of a signal received by a mobile device from a base station of the one or more base stations, where the base station is associated with the code, and (b) information indicating a distance between the mobile device and the base station; (4) the signal strength information of the signal received by the mobile device from the base station of the one or more base stations and information indicating a data throughput between the mobile device and the base station; (5) a first number of base stations associated with the code in a first area, and a second number of base stations associated with a second code in a second area, where the first area and the second area are separated by a distance less than a threshold separation value; or (6) an area of coverage of a base station of the one or more base stations associated with the code. In some embodiments, determining whether a code from the one or more codes is associated with the small cell is based on one or more techniques selected from the group consisting of (1) to (6).

In some embodiments of the non-transitory computer-readable storage medium, determining whether the code is associated with the small cell is at least based on the number of the one or more base stations associated with the code, where the number of the one or more base stations associated with the location area code or the tracking area code is greater than, for example, one thousand (1,000).

In some embodiments of the non-transitory computer-readable storage medium, determining whether the code is associated with the small cell is at least based on both the signal strength information of the signal and the information indicating the distance between the mobile device and the base station, where the signal strength information of the signal indicates a signal strength below a threshold power level and the distance between the mobile device and the base station is less than a threshold distance value.

In some embodiments of the non-transitory computer-readable storage medium, determining whether the code is associated with the small cell is at least based on the signal strength information of the signal received by the mobile device from the base station and the information indicating the data throughput between the mobile device and the base station, where the signal strength information indicates a signal strength below a threshold power level and the data throughput is greater than a threshold data rate value.

In some embodiments of the non-transitory computer-readable storage medium, the machine-readable instructions, when executed by the one or more processing units, further cause the one or more processing units to, based on determining that the code is associated with the small cell, send assistance data to a wireless device, wherein data associated with base stations associated with the code is excluded from the assistance data to be sent to the wireless device. In some embodiments, the machine-readable instructions, when executed by the one or more processing units, further cause the one or more processing units to, based on determining that the code is associated with the small cell, determine that a location of a second mobile device in communication with a second base station associated with the code is a location of the second base station.

In accordance with still another example implementation, an apparatus may be provided which may comprise means for receiving information associated with one or more base stations, where the information associated with the one or more base stations includes one or more codes associated with the one or more base stations; and means for determining whether a code from the one or more codes is associated with a small cell based on at least one of (1) a number of the one or more base stations associated with the code; (2) an aggregated area of coverage of the one or more base stations associated with the code; (3) both (a) a signal strength information of a signal, received by a mobile device from a base station of the one or more base stations, where the base station is associated with the code, and (b) information indicating a distance between the mobile device and the base station; (4) the signal strength information of the signal received by the mobile device from the base station of the one or more base stations and information indicating a data throughput between the mobile device and the base station; (5) a first number of base stations associated with the code in a first area, and a second number of base stations associated with a second code in a second area, where the first area and the second area are separated by a distance less than a threshold separation value; or (6) an area of coverage of a base station of the one or more base stations associated with the code. In some embodiments, determining whether a code from the one or more codes is associated with a small cell is based on one or more techniques selected from the group consisting of (1) to (6).

In some embodiments of the apparatus, the signal strength information includes a received signal strength indicator (RSSI); and the information indicating the distance between the mobile device and the base station includes at least one of a time of flight (TOF), a time of arrival (TOA), or a round trip time (RTT) of the signal.

In some embodiments, the apparatus further comprises means for, based on determining that the code is associated with the small cell, determining a location of a second mobile device in communication with a second base station associated with the code based on a location of the second base station.

### BRIEF DESCRIPTION OF THE DRAWINGS

Aspects of the present disclosure are illustrated by way of example. Non-limiting and non-exhaustive aspects are described with reference to the following figures, wherein like reference numerals refer to like parts throughout the various figures unless otherwise specified.

FIG. 1 is a simplified illustration of an example positioning system, according to certain aspects of the present disclosure.

FIG. 2 illustrates a simplified example communication system including small cells, according to certain aspects of the present disclosure.

FIG. 3 illustrates example small cells associated with a single location area code.

FIG. 4 illustrates example small cells associated with three location area codes.

FIG. 5 illustrates an example where a small cell is moved without changing the associated location area code.

FIG. 6 illustrates example coverage areas of macro cells and small cells.

FIG. 7 is a flow chart illustrating an example method of identifying small cells based on a number of cells associated with a code, according to certain aspects of the present disclosure.

FIG. 8 is a flow chart illustrating another example method of identifying small cells based on an aggregated area of coverage of a plurality of cells associated with a code, according to certain aspects of the present disclosure.

FIG. 9 illustrates example requirements on small cell transmission power.

FIG. 10 is a flow chart illustrating an example method of identifying small cells based on signal strength information, according to certain aspects of the present disclosure.

FIG. 11 illustrates example data throughputs of small cells.

FIG. 12 is a flow chart illustrating an example method of identifying small cells based on data throughput, according to certain aspects of the present disclosure.

FIG. 13 is a flow chart illustrating an example method of identifying small cells based on a determination that only a single cell in an area is associated with a code, according to certain aspects of the present disclosure.

FIG. 14 is a flow chart illustrating an example method of identifying small cells based on a determination that a cell associated with a certain code is in close proximity to cells associated with a different code, according to certain aspects of the present disclosure.

FIG. 15 is a flow chart illustrating an example method of identifying small cells based on a coverage area of a cell, according to certain aspects of the present disclosure.

FIG. 16 is a simplified block diagram of an embodiment of a wireless device.

FIG. 17 is a simplified block diagram of an embodiment of a computing system.

### DETAILED DESCRIPTION

Several illustrative embodiments will now be described with respect to the accompanying drawings, which form a part hereof. The ensuing description provides embodiment(s) only, and is not intended to limit the scope, applicability or configuration of the disclosure. Rather, the ensuing description of the embodiment(s) will provide those skilled in the art with an enabling description for implementing an embodiment. It is understood that various changes may be made in the function and arrangement of elements without departing from the spirit and scope of this disclosure.

Location information of macro cells and small cells may be used in many applications. For example, the locations of the antenna (base station) of the macro cells and small cell may be sent as assistance data to a mobile device and allow the mobile device to determine the location of the mobile device. However, a service area may include tens of thousands of small cells. As such, a large amount of assistance data may need to be sent to the mobile device, and thus may push data associated with macro cells out of the memory of the mobile device. In some circumstances, a small cell, such as a femtocell, may be moved from one area to another area without changing a location area code. Thus, the assumption that a location area is localized may no longer be valid, and thus may result in wrong or inaccurate positioning. Therefore, it is desirable to identify small cells or distinguish small cells from macro cells.

Disclosed herein are several techniques for identifying small cells, including femtocells, which may be used independently or in any combination to identify small cells. Further aspects of this disclosure relate to using the identified small cell information for mobile device positioning. Some of these techniques may be performed by a single mobile device, some techniques may be performed by a server using crowdsourcing data collected by one or more mobile devices or servers, while some techniques may be performed by one or more mobile device or one or more servers.

Wireless communication systems may comprise wireless devices, access points (APs), and base transceiver stations, which may allow the wireless devices to connect to a wired or wireless network using one or more wireless standards or air interface types. Wireless communication systems may also be used as a positioning system for determining the positions of the constituents of the system, such as a mobile device.

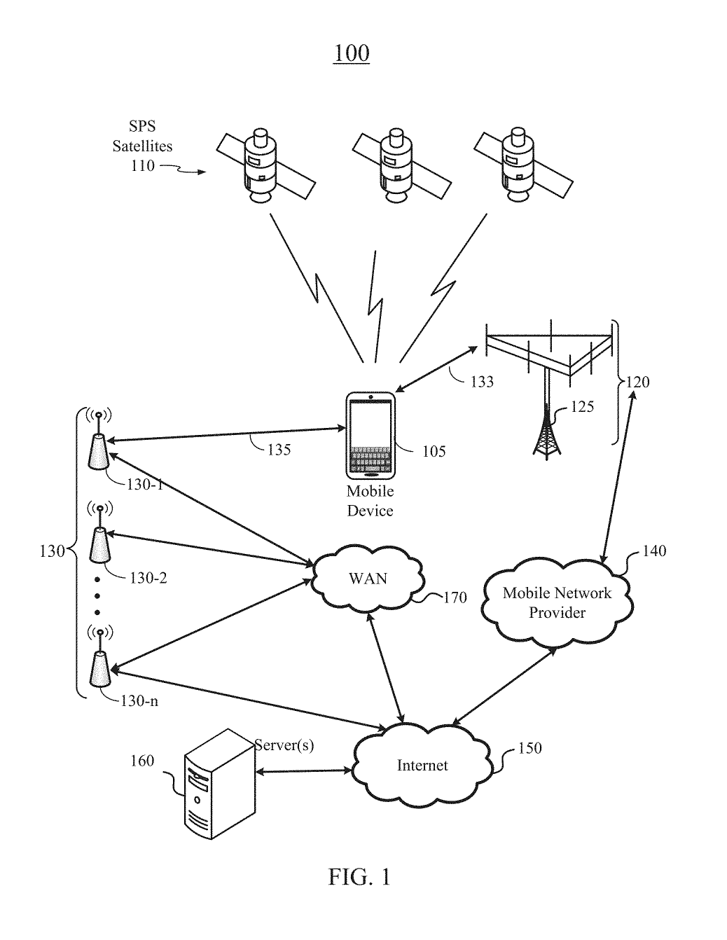

FIG. 1 is a simplified illustration of a positioning system 100, according to certain aspects of this disclosure, which may be used to implement various techniques described herein. Positioning system 100 may include at least some of a mobile device 105, Satellite Positioning System (SPS) satellites 110, base transceiver station(s) 120, a mobile network provider's network 140, access point(s) 130, server(s) 160, a wireless area network (WAN) 170, and the Internet 150. Mobile device 105 and/or other constituents of positioning system 100, such as server(s) 160, can process measurements and/or other data points to determine the position of mobile device 105. It should be noted that FIG. 1 provides only a generalized illustration of various components, any or all of which may be utilized as appropriate, and each of which may be duplicated as appropriate. Specifically, although only one mobile device 105 is illustrated, it will be understood that many mobile devices (e.g., hundreds, thousands, or more) may be utilized in positioning system 100. Similarly, positioning system 100 may include many base transceiver stations (similar to base transceiver station 120) and/or a larger or smaller number of APs 130. Connections between illustrated components may include additional (intermediary) components, direct or indirect connections, and/or additional networks. Furthermore, components may be rearranged, combined, separated, substituted, and/or omitted, depending on desired functionality. A person of ordinary skill in the art will recognize many modifications to the components illustrated.

Base transceiver station(s) 120 may include one or more antennas installed on an antenna supporting structure 125 for communicating with mobile device 105. Base transceiver station(s) 120 may also be communicatively coupled to mobile network provider's network 140 (e.g., a cellular network), which may be communicatively coupled with the Internet 150. Server(s) 160 can also be communicatively coupled with the Internet 150. Thus, mobile device 105 can communicate information with the server(s) 160, for example, by accessing the Internet 150 via the base transceiver station(s) 120 using a first communication link 133. Additionally or alternatively, because APs 130 and WAN 170 may also be communicatively coupled with the Internet 150, mobile device 105 may communicate with server(s) 160 using a second communication link 135.

As shown in FIG. 1, there may be a plurality of APs 130, some or all of which may be detected by mobile device 105. Although FIG. 1 shows mobile device 105 having a communication link (second communication link 135) with only one AP 130-1, 130-2, . . . , or 130-n, other configurations or embodiments may allow for multiple communication links with multiple APs 130. Additionally or alternatively, mobile device 105 may establish communication links with different APs 130 at different times.

Depending on desired functionality, a location of mobile device 105 may be determined in any of a variety of ways, by mobile device 105 and/or other devices in communication with the mobile device, which may be situation dependent, using, for example, location assistance data provided to mobile device 105 and/or other devices in communication with the mobile device. In some embodiments, server(s) 160 and/or other devices (not shown) remote to mobile device 105 may be used to implement positioning methods for supporting the positioning of mobile device 105, which may be referred to as a target mobile device, target device, or target. These positioning methods may include, for example, measurements by one or more mobile devices of wireless signals transmitted by SPS satellites 110, base transceiver station(s) 120 belonging to a wireless cellular network (e.g., mobile network provider's network 140), APs 130, and the like.

In addition (or as an alternative) to these position-determination methods, techniques described herein can utilize server(s) 160 that receive “crowdsourced” information from one or more mobile devices regarding one or more APs 130 and/or one or more base transceiver stations (similar to base transceiver station 120). Server(s) 160 may gather information from a plurality of mobile devices and determine the location of an AP or a base transceiver station. In some embodiments, the information may include received signal strength indicator (RSSI) and/or round trip time (RTT) measurements for each AP or each base receiver station. In some embodiments, server(s) 160 may wait to determine the location of an AP 130-1, 130-2, . . . , or 130-n, or a base transceiver station 120 and add the determined location to a database until AP 130-1, 130-2, . . . , or 130-n, or base transceiver station 120 has been identified by a threshold number of mobile devices (similar to mobile device 105) and/or by a threshold number of received crowdsourcing data samples.

Server(s) 160 may also determine the locations of AP(s) 130 and/or base transceiver station(s) 120 based on map data received, for example, from a Geographic Information System (GIS) and/or other databases such as Google Maps or Google Earth, alone or in combination with other data.

Mobile device(s) 105 and/or server(s) 160 of FIG. 1 may determine a location of a mobile device 105, a base transceiver station 120, or an AP 130-1, 130-2, . . . , or 130-n, using various techniques based on the RSSI and/or time of flight or RTT measurements for each AP or base transceiver station. For example, multi-laterations or multi-angulations techniques, such as a trilateration or triangulation technique, may be used for determining the location of a mobile device 105, base transceiver station 120, or AP 130-1, 130-2, . . . , or 130-n.

In some cases, there may be dead zones or zones with poor cellular signal reception in a wireless communication network of a service provider, such as, for example, areas between different cells or areas too far from a base station of any cell. Small cells, such as microcells, picocells, or femtocells, may be used to extend the service coverage to these zones where access to the wireless communication network would otherwise be limited or unavailable.

Small cells are low-power radio access nodes that operate in licensed or unlicensed spectrum and have a radius of coverage (which may be referred to as “footprint,” defined as distance from radio access node where a mobile station may still detect a transmitted signal) of less than about 1 or 2 kilometers, and, in some cases, even less than 1 kilometer. However, it is understood that radio access nodes of different ranges of coverage may be considered a small cell. In various examples, the range of a small cell may be less than two (2) kilometers or less, two hundred (200) meters or less, or on order of ten (10) meters. They are small compared to a mobile macro cell, which may have a radius of coverage of a few tens of kilometers, for example thirty (30) or forty (40) kilometers. A subset of small cells is femtocells. Each femtocell may include a low-power cellular base station, typically designed for use in a home or small business to avoid dead zones or zones with poor cellular signal reception. A femtocell connects to a mobile network provider's network via broadband Internet access (e.g., DSL, cable, fiber), allowing the mobile network provider to extend service coverage indoors or at the cell edge, especially where access would otherwise be limited or unavailable. Small cells can communicate over a wired network, and thus can reduce air traffic. Furthermore, small cells are generally not powered by batteries, and therefore may not be power-constrained. In some implementations, a small cell can be relatively easily moved, and hence, a database mapping cell identities to geographical locations may need to be updated more rapidly than typical macro cell implementations.

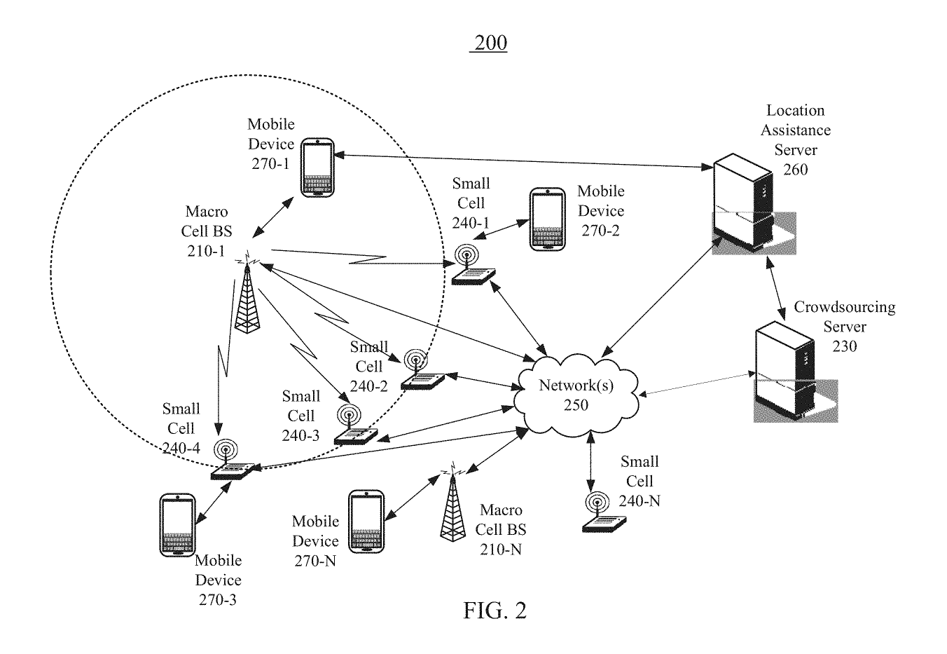

FIG. 2 illustrates a simplified example communication system 200 including small cells, according to certain aspects of the present disclosure. Communication system 200 may include multiple macro cells represented by macro cell base stations 210-1, . . . , and 210-N. Mobile devices, for example, mobile devices 270-1 and 270-N may communicate with communication system 200 through macro cell base stations 210-1, . . . , and 210-N, as in a typical wireless communication system. Certain areas may not be covered by any one of the macro cells or may have weak cellular signals. One or more small cells 240-1, 240-2, 240-3, 240-4, . . . , and 240-N may be added in such areas to improve the quality of services in these areas. These small cells may be connected to one or more networks 250 via broadband Internet access, allowing mobile devices in these areas, such as mobile devices 270-2 and 270-3, to communicate with other mobile devices or servers through network(s) 250.

In one or more arrangements, network(s) 250 may provide connectivity to one or more other wired and/or wireless networks included in communication system 200. For example, network(s) 250 may be an Internet Protocol (IP) network, such as the Internet. In another example, network(s) 250 may be a mobile network provider's private network. Network(s) 250 may provide connectivity between crowdsourcing server 230, small cells 240-1, . . . and 240-N, and mobile devices 270-1, . . . , and 270-N.

In one or more arrangements, network(s) 250 may include a wireless network subsystem, which may include one or more systems and components for providing wireless telephony and data networks, such as one or more gateways, switches, routers, controllers, registers, billing centers, service centers, mobile switching centers, base station controllers, and/or other systems and components. These systems and components may, for example, enable a wireless network subsystem to control one or more wireless base stations, such as macro cell base station 210-1, . . . , and 210-N, which may transmit and receive radio frequency (RF) signals to and/or from one or more mobile devices on the network(s) provided by wireless network subsystem.

In one or more arrangements, network(s) 250 may include a broadband network gateway, which may include one or more systems and components for providing wired telephony and data networks, such as one or more gateways, switches, and/or routers, as well as one or more optical, coaxial, and/or hybrid fiber-coaxial lines, one or more satellite links, one or more radio links, and/or other systems and components. These systems and components may, for example, enable a broadband network gateway to provide telephone services and/or data/Internet access to one or more user devices at various locations.

Communication system 200 may also include a crowdsourcing server 230. In one or more arrangements, crowdsourcing server 230 may be configured to access, store, and/or maintain a database in which information about the wireless signals that are observable at various locations by one or more mobile devices and/or access points may be stored. For example, via network(s) 250, crowdsourcing server 230 may receive information about wireless signals observed at particular locations from mobile devices 270-1, 270-2, 270-3, . . . , and 270-N, and/or macro cell base stations 210-1, . . . , and 210-N and/or small cells 240-1, 240-2, 240-3, 240-4, . . . , and 240-N. Crowdsourcing server 230 may aggregate, refine, and/or filter such information, and perform other functions associated with maintaining the server, such as updating uncertainty values and/or reliability factors corresponding to various measurements.

Communication system 200 may also include a location assistance server 260 configured to interact with devices in communication system 200 via a network, so as to assist mobile devices in estimating their positions. Position determination may be performed with or without use of information from crowdsourcing server 230. For example, the location assistance server 260 may be configured to calculate and return a position for a mobile device that provides signal observations to the location assistance server 260. Additionally or alternatively, location assistance server 260 may be configured to select regional information from the crowdsourcing server or any other data source based on a coarse position estimate provided by a mobile device 270, and subsequently provide such regional information to the mobile device 270 in order to enable the mobile device to calculate a more accurate estimate of its own position. For example, location assistance server 260 and/or crowdsourcing server 230 may provide position assistance data to mobile devices for the mobile device to determine its own position. The position assistance data may include, for example, position information of macro cell base stations and small cell base stations, which may be used by the mobile device to determine its position based on the locations of multiple base stations and the distances between the mobile device and the multiple base stations, using, for example, trilateration or triangulation techniques.

While crowdsourcing server 230 and location assistance server 260 are illustrated in FIG. 2 as separate servers, in some embodiments, crowdsourcing server 230 and location assistance server 260 may be combined into a single server that performs any or all of the functionalities that each server may provide individually. For example, crowdsourcing server 230 may, in some embodiments, also provide any or all of the functionalities of location assistance server 260, in addition to the other functionalities provided by crowdsourcing server 230. In still other embodiments, the functionalities of crowdsourcing server 230 and/or location assistance server 260 may be provided by any number of different servers and/or other computing devices, which may be located in a same physical place or in any number of different physical places. In some implementations, the position assistance data may not be crowdsourced, and may be provided by, for example, a network service provider.

A regular cell phone macro cell may have unique identifiers (IDs), the format of which may vary with the air interface technology used. For example, for a Global System for Mobile communication (GSM) macro cell, the unique IDs may include a Mobile Country Code (MCC) as a first identifier (ID1) to identify a country, a Mobile Network Code (MNC) code as a second identifier (ID2) to identify a mobile network provider, a Location Area Code (LAC) as a third identifier (ID3) to identify a location area, and a Cell ID (CID) as a fourth identifier (ID4) to identify a base transceiver station (BTS) or sector of the BTS within the location area. In the following description, LAC may be used as an example third identifier (ID3) for a cell. However, in a different wireless communication standard, a different ID3 may be used. For example, a tracking area code (TAC) may be used as the ID3 for long-term evolution (LTE), and other ID3s may be used for other air interface types. Hence, generally speaking, a LAC and a TAC are both examples of a code for identifying a location area within a wireless network. However, as will be shown in the discussion below, in some cases, a specific code may not be associated with a location area, and may instead be associated with small cells over, in certain cases, a relatively large geographic area. It is understood that various embodiments described below with reference to location area codes or tracking area codes can apply generally to any code corresponding to an ID3 in a wireless network, and not only LACs or TACs.

In general, a set of cells, such as, for example, a few hundreds (e.g., about two hundred (200) to about five hundred (500)) macro cells, may be grouped together in a location area to optimize signaling, for example, to avoid paging by all cells. A unique number, such as, for example, the LAC for GSM macro cell or the TAC for LTE macro cell, may be assigned to each location area. Thus, cells sharing the same LAC may be localized within a limited area. The location area code may be broadcast by each cell at regular intervals. The LAC or TAC may be used to identify subscriber station location for a variety of reasons, most notably to direct incoming voice and data traffic, including emergency calls, to appropriate paging transmitters. In some cases, if the location information of a cell is unknown to a user other than the provider of the cell, the location of the center of the location area associated with the LAC or TAC of the cell may be set as the fallback location of the cell.

For technical reasons, a femtocell may have a LAC/TAC that is different from the underlying macro cell. For example, in general, a mobile network provider may reserve a certain range of LACs/TACs for the femtocells. In some cases, some macro cells and small cells may share a same LAC/TAC. As a result, tens of thousands of cells (many being small cells), rather than a few hundreds of cells (e.g., macro cells), may share a location area code. In general, cells having the same LAC may be localized within a limited area. However, in some circumstances, a location area for a location area code associated with small cells may cover a very large area.

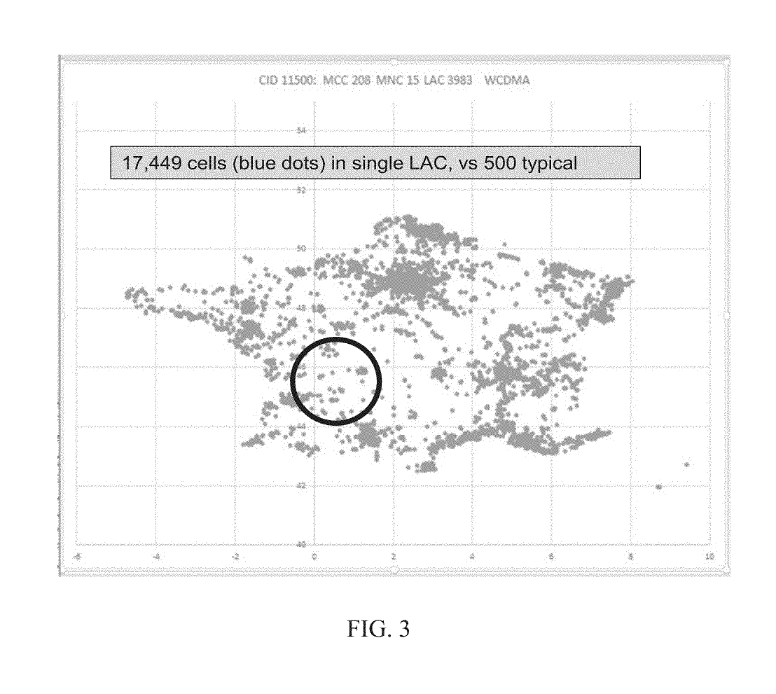

FIG. 3 illustrates example small cells associated with a single location area code across France. In FIG. 3, each dot represents a Wideband Code Division Multiple Access (W-CDMA) small cell, such as a femtocell. The circle represents a typical localized region for a LAC, which may include, for example, less than about 500 macro cells. As shown in the example of FIG. 3, about 17,449 cells share a single W-CDMA LAC (3983 in the example), and the about 17,449 cells are distributed across the entire area of France. FIG. 3 shows that, contrary to the typical case, in some cases, cells having the same LAC may not be localized within a limited area. As such, using the center of the location area associated with the LAC of the cell as the fallback location of the cell may be very inaccurate. Furthermore, with tens of thousands of cells sharing a location area code, it may be difficult to decide what assistance data to send to a mobile device and therefore, the location assistance server or crowdsourcing server may send information of all cells in a service area to the mobile device, which may occupy a large memory space on the mobile device, and may sometimes push more useful data associated with macro cells out of the memory of the mobile device.

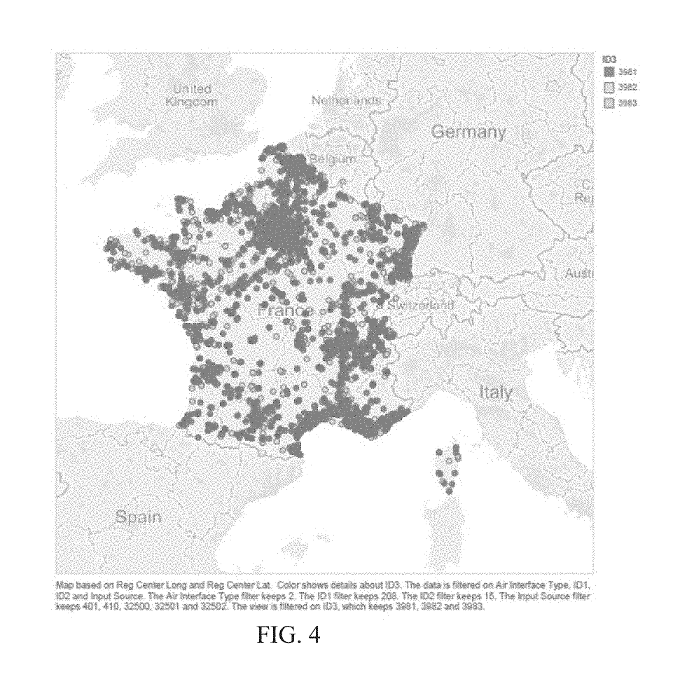

FIG. 4 illustrates example small cells associated with three example location area codes across France. As shown in FIG. 4, W-CDMA small cells associated with each of location area codes 3981, 3982, and 3983 may be located anywhere in the entire area of France, and location areas for the different location area codes are largely overlapping with each other. Therefore, with small cells, an ID3 code, such as a location area code, may no longer be associated with a localized area. In such a case, the ID3 code may be associated with a plurality of small cells throughout a large geographic area. Unlike more typical uses of the ID3 code, that is to identify a localized area, the ID3 code may instead be associated with a plurality of small cells. Other cells associated with the same code may also be small cells.

Once installed in a specific location, most small cells have protection mechanisms so that a location change will be reported to the mobile network provider. In general, a small cell, such as a femtocell, may have built-in Global Positioning System (GPS) unit to determine a location of the femtocell, but may not broadcast its location in many situations. Thus, a location change of a femtocell may not be known by a party other than the mobile network provider. Whether the mobile network provider allows femtocells to operate in a different location depends on the mobile network provider's policy. In some circumstances, a femtocell may be moved from one area to another area without changing its ID3, such as a LAC. Thus, the assumption that a location area is localized may not be valid in some circumstances, because a small cell may change locations without changing its ID3.

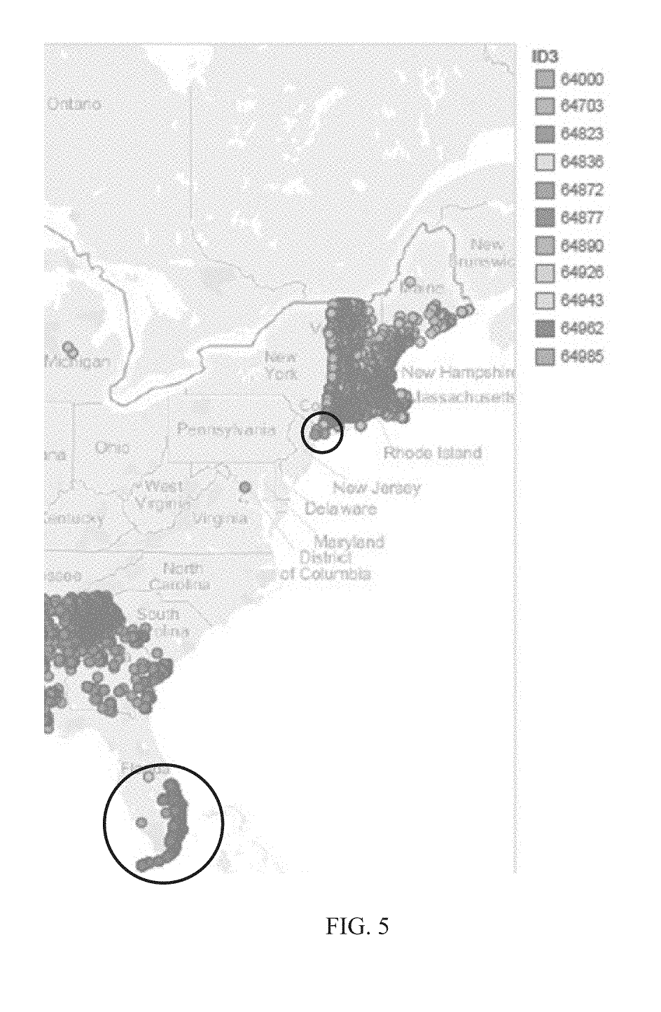

FIG. 5 illustrates an example where a small cell is moved without changing the associated location area code, thus breaking the regionalization associated with a location area code. As shown in FIG. 5, cells with a location area code 64782 are mostly located in south Florida, but one cell with location area code 64782 may show up in New York because a user can easily take a small cell base station to a new location and set up a new small cell at the new location. Thus, over time, cells with the same location area code may spread out in different areas in a country.

As described above, for macro cells, if the location of a macro cell is unknown, the location of the center of the location area associated with the LAC of the macro cell may be an acceptable estimation of the macro cell. However, as shown in FIGS. 3-5, for small cells, if an actual location of a small cell cannot be found by a user other than the mobile network provider, the location of the center of the location area associated with the LAC may be far away from the actual location of the femtocell, and thus may cause wrong or very inaccurate positioning if the location of the center of the location area is used as the location of the femtocell.

In addition, a small cell, such as a femtocell, may have a radius of coverage of less than about fifty (50) meters, or even less than about twenty (20) or ten (10) meters. If a small cell is not correctly identified and it is assumed that the radius of coverage of the cell is on order of tens of kilometers as a macro cell, the cellular signal coverage of an area may be over-estimated.

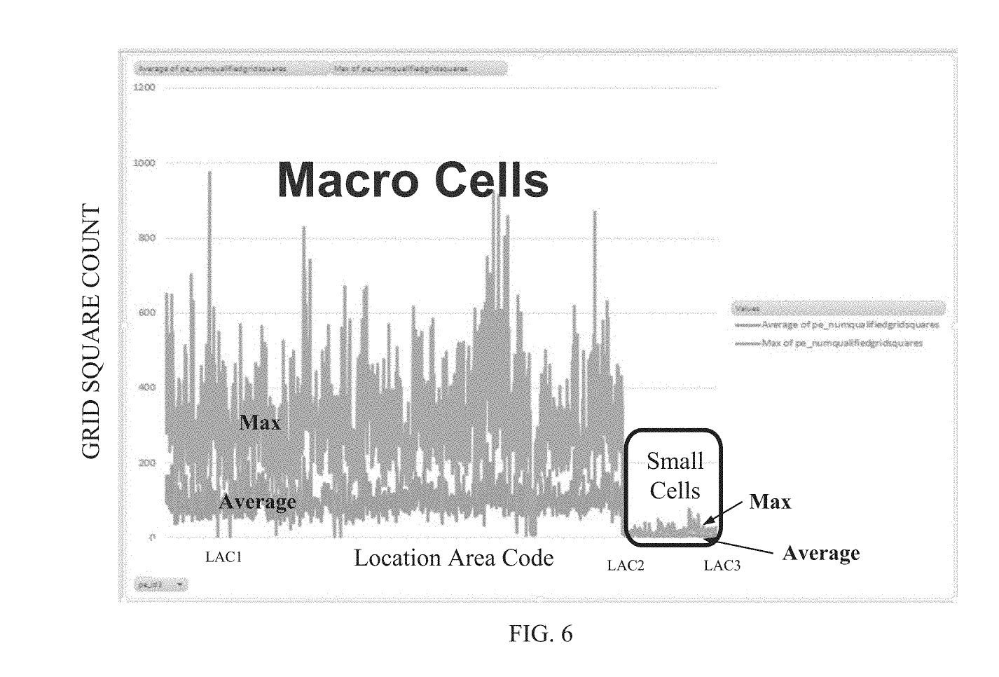

FIG. 6 illustrates example coverage areas of macro cells and small cells. In FIG. 6, average and maximum coverage areas of W-CDMA cells with different location area codes are shown as indicated. These cells are operated by a same wireless service provider. As shown in FIG. 6, for cells with LACs ranging from about LAC1 to about LAC2, the average coverage area of the cells sharing a LAC is about 100 grid squares, and the typical maximum coverage area of the cells sharing a LAC is about three hundred (300) grid squares, where, in this example, each grid square is a twenty five (25) meter×twenty five (25) meter block. For cells with LACs ranging from about LAC2 to LAC3, the average coverage area of cells sharing a LAC is only about 5 grid squares, while the typical maximum coverage area of cells sharing a LAC is only about 10 grid squares. Thus, there is a dramatic drop in average coverage area and maximum coverage area for cells with LACs between about LAC2 and LAC3, which may be assigned to small cells only by the wireless service provider.

For various reasons, such as the ones stated above, it is desirable to identify small cells or distinguish small cells from macro cells when generating assistance data for mobile device positioning. Small cells may be identified using look-up tables provided by mobile network provider or based on an estimated coverage area of each individual cell. However, the look-up tables from the mobile network provider may not be readily available. Furthermore, as described above, small cells may be easily moved and reinstalled at new locations, and thus even the look-up tables from the mobile network provider may not include real-time or most updated information regarding small cells. Therefore, an automated solution to identify small cells, properly estimate the coverage footprints of the small cells, and selectively report locations of these small cells in assistance data may be needed and beneficial to both wireless network providers and the end users.

Embodiments disclosed herein provide various techniques to identify small cells. These techniques may be used separately or in combination to identify small cells and use the identified small cell information for mobile device positioning. Some of the techniques may be performed by a single mobile device, while some other techniques may be performed by a server using crowdsourcing data collected by a plurality of mobile devices or servers. Some other techniques may be performed by either a mobile device or a crowdsourcing server.

One technique to identify small cells is based on the number of cells that share a same ID3 (e.g., LAC, TAC, etc.). In general, a location area may include about two hundred (200) to five hundred (500) macro cells. Thus, if the number of cells that share a same LAC are much larger than about two to five hundred, such as a thousand (1,000) or more, the cells would likely include small cells, including femtocells. In various embodiments, the information regarding the number of cells having the same ID3 may be collected by one or more mobile devices, for example, by crowdsourcing broadcast data from cells collected by multiple mobile devices, where the broadcast data includes the LAC information of the cells.

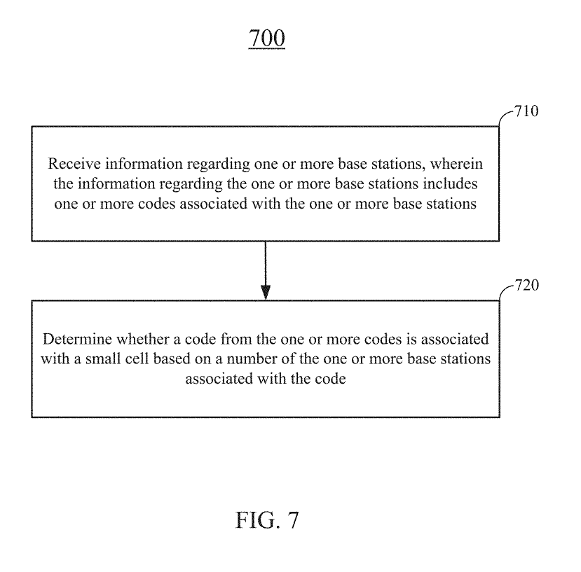

FIG. 7 is a flow chart 700 illustrating an example method of identifying small cells based on a number of cells associated with a code, according to certain aspects of the present disclosure. At block 710, a server, such as crowdsourcing server 230 and/or location assistance server 260 of FIG. 2, may receive information regarding one or more base stations from one or more mobile devices, where the information regarding each of the one or more base stations includes a code, for example, an ID3 code such as a location area code or a tracking area code, of the cell associated with the base station.

At block 720, the server may determine whether a code, such as a location area code or a tracking area code, is associated with a small cell based on a number of base stations associated with the code. For example, if the server determines, based on the crowdsourced data regarding the one or more base stations, that there are more than, for example, one thousand (1,000) base stations associated with the same location area code or tracking area code, the server may determine that the location area code or tracking area code is associated with small cells, or at least some of the base stations associated with the location area code or tracking area code are associated with small cells.

Another technique to identify femtocells is based on the aggregated area of coverage of an ID3. Because a location area for a set of macro cells is localized to a limited area, if the coverage area of a particular ID3 is very large, the location area identified by the ID3 may be associated with small cells, rather than macro cells. Again, the aggregated area of coverage of an ID3 may be obtained by one or more mobile devices. For example, a mobile device may traverse a large area to collect the ID3 information of cells in the area. More efficiently, multiple mobile devices, such as hundreds, thousands, or tens of thousands of mobile devices in a large area may collect ID3 information associated with the cells in the large area, and the collected ID3 information may be crowdsourced to determine the aggregated area of coverage of the ID3 by a server based on the area in which signals transmitted by base stations sharing the ID3 can be detected.

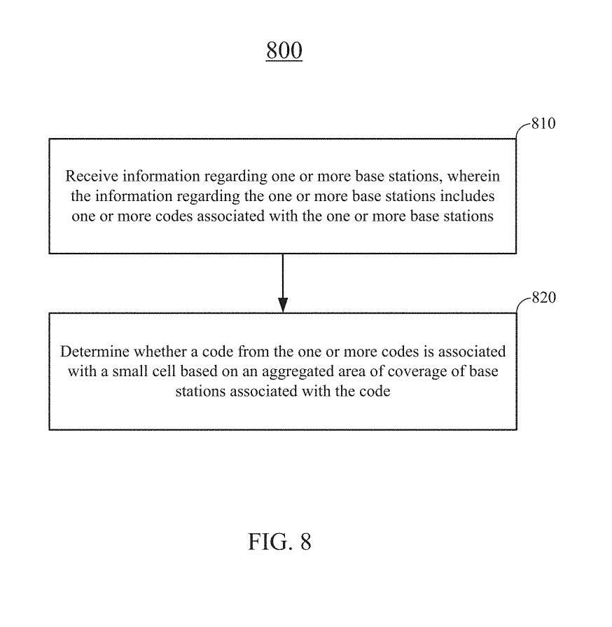

FIG. 8 is a flow chart 800 illustrating another example method of identifying small cells based on an aggregated area of coverage of a plurality of cells associated with a code, according to certain aspects of the present disclosure. At block 810, a server, such as crowdsourcing server 230 and/or location assistance server 260, may receive information regarding one or more base stations associated with one or more cells from one or more mobile devices, where the information regarding each of the one or more base stations includes a code, such as a location area code or a tracking area code, of the cell associated with the base station. In some cases, the information regarding each of the one or more base stations may include the location information of at least some base stations. For example, some cells may broadcast their location information to the mobile devices, which may forward such information to the server. In some cases, the locations of the base stations may be estimated based on the locations of the mobile devices that report the information to the server. In some cases, the information regarding each base station may include the location where a signal transmitted by the base station may be detected by the mobile device.

At block 820, the server may determine whether a code, such as a location area code or a tracking area code, is associated with a small cell based on an aggregated area of coverage of the base stations associated with the code. The server may determine the aggregated area of coverage of the base stations associated with the location area code or the tracking area code, for example, based on the crowdsourced (estimated) locations of the base stations and/or reported locations where a signal transmitted by the base stations was detected by the mobile device. When the aggregated area of coverage of the base stations associated with the location area code or the tracking area code is greater than, for example, one thousand (1,000) square kilometers, the server may determine that the location area code or the tracking area code is associated with small cells or at least some of the base stations associated with the location area code or the tracking area code are associated with small cells.

In some embodiments, a mobile device may determine whether a code is associated with a small cell based on a number of base stations associated with the code, or based on an aggregated area of coverage of the base stations associated with the code. For example, if the mobile device determines that, in a certain geographic area (e.g., over two hundred fifty (250) square kilometers), only one base station is associated with an ID3 code, while there are multiple based stations associated with a different ID3 code in the same area, the mobile device may conclude that the ID3 code is associated with a small cell. As another example, if the mobile device finds a first base station associated with an ID3 code (e.g., a LAC or a TAC) in a first location, and another base station associated with the same ID3 code in a second location separated from the first location over a threshold distance (e.g., eighty (80) kilometers), the mobile device may determine that the ID3 code is associated with small cells. Optionally, the mobile device may report the code that is associated with a small cell to a server.

In some embodiments, a mobile device may identify a small cell without using crowdsourced data. For example, in some embodiments, a mobile device may identify a small cell using the RSSI of an RF signal from a cell and a timing information of an RF signal transmitted between the mobile device and the cell. The timing information may include, for example, a time of flight (TOF), a time of arrival (TOA), a round trip time (RTT) of the RF signal, that can be used to determine a distance between the mobile device and a base station of the cell.

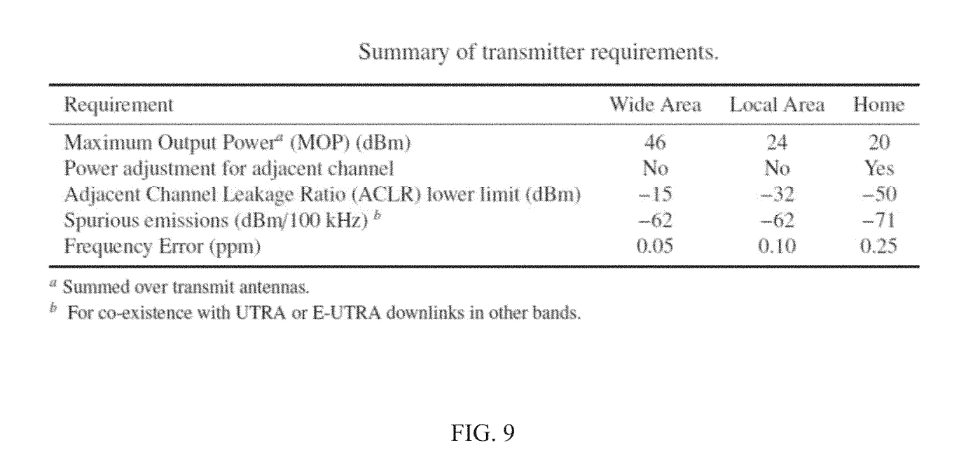

FIG. 9 illustrates example requirements on transmission power for small cells and macro cells. For example, the maximum output power (MOP) of a macro cell may be about 46 dBm or higher, the MOP of a small cell may be 24 dBm or higher, and the MOP of a femtocell for a home may be 20 dBm or higher. Therefore, in general, a small cell's MOP is about 22-26 dBm lower than the MOP of a macro cell.

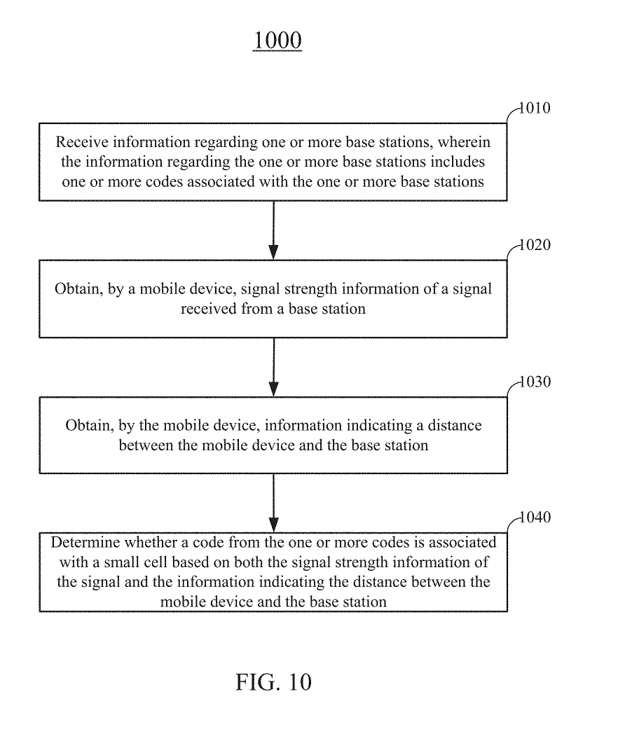

FIG. 10 is a flow chart 1000 illustrating an example method of identifying small cells based on signal strength information, according to certain aspects of the present disclosure. At block 1010, a server, such as crowdsourcing server 230 and/or location assistance server 260 of FIG. 2, or a mobile device may receive information regarding one or more base stations from one or more mobile devices or servers, where the information regarding each of the one or more base stations may include a code, for example, an ID3 code such as a location area code or a tracking area code, of the cell associated with the base station.

At block 1020, a mobile device may obtain signal strength information (e.g., RSSI) of an RF signal received from a base station associated with a cell. If the RSSI of the RF signal received by the mobile device from the base station is low, it may indicate that the cell is either a close-by small cell or a macro cell whose base station is far away from the cell. If the RSSI of the RF signal received by the mobile device from a cell is higher than a threshold power level, such as, for example, thirty (30) dBm, it may indicate that the cell is not a small cell.

At block 1030, the mobile device may obtain information indicating a distance between the mobile device and the base station associated with the cell. As described above, the distance information may be indicated by an RTT or a TOF calculated from, for example, a TOA and/or time of departure (TOD) of the RF signal. If the timing information indicates that the distance between the base station of the cell and the mobile device is less than a threshold distance value, such as, for example, five hundred (500), two hundred (200), or one hundred (100) meters, the base station of the cell may be close to the mobile device.

At block 1040, the mobile device may determine whether a code from the one or more codes is associated with a small cell based on both the signal strength information of the signal and the information indicating the distance between the mobile device and the base station. For example, if the RSSI of a signal from a base station associated with a code is low and the distance between the base station and the mobile device is less than the threshold distance value, such as, for example, five hundred (500), two hundred (200), or one hundred (100) meters, the base station associated with a code is close to the mobile device and has a low MOP, and thus is most likely associated with a small cell. The mobile device may then communicate with a crowdsourcing server to indicate that the base station is associated with a small cell, or that the code associated with the base station is associated with small cells. The crowdsourcing server may collect such information from multiple mobile devices, and use the information collected from the multiple mobile devices to cross-verify the accuracy of the information.

In general, only a limited number of mobile devices may communicate with a small cell, such as a femtocell, at a given time. For example, in a residential setting, up to about four (4) to eight (8) active mobile devices may communicate with a cell at a given time. In an enterprise setting, up to about eight (8) to sixteen (16) active mobile devices may communicate with a cell at any given time. Therefore, the data rate of the communication between a mobile device and a small cell may be high. On the other hand, the number of mobile devices that communicate with a macro cell at a given time may be much higher. Therefore, the communication data rate between a mobile device and a macro cell may be limited.

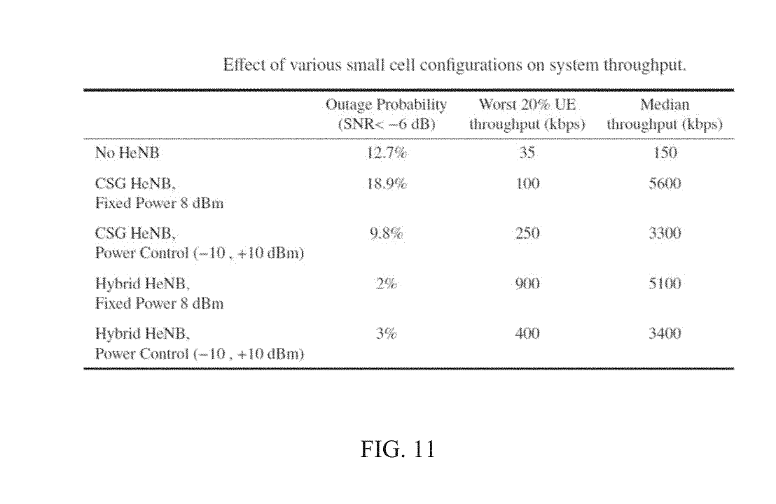

FIG. 11 illustrates example data throughputs of small cells. FIG. 11 indicates that the medium throughput of a small cell may be over 3 Mbps even when the signal strength is below 10 dBm. Therefore, the combination of a high data throughput between the cell and the mobile device and a small RSSI of an RF signal from the cell may also indicate that the cell is a close-by small cell. As such, more generally, it can be inferred that a cell is a small cell when signal strength information indicates a signal strength for the cell is below a threshold power level and the data throughput for the cell is greater than a threshold data rate value.

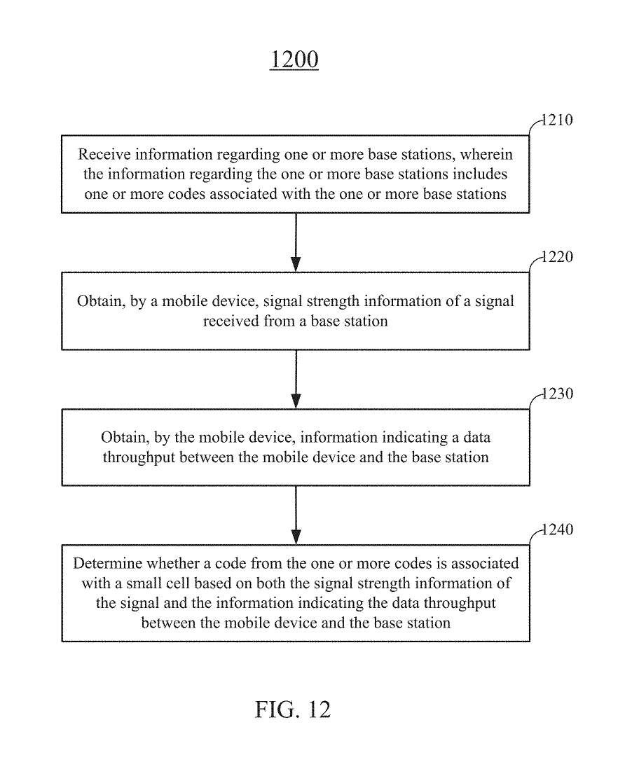

FIG. 12 is a flow chart 1200 illustrating an example method of identifying small cells based on data throughput, according to certain aspects of the present disclosure. At block 1210, a server, such as crowdsourcing server 230 and/or location assistance server 260 of FIG. 2, or a mobile device may receive information regarding one or more base stations from one or more mobile devices or servers, where the information regarding each of the one or more base stations includes a code, for example, an ID3 code such as a location area code or a tracking area code, of the cell associated with the base station.

At block 1220, a mobile device may obtain signal strength information, such as RSSI, of a signal received from a base station associated with a code from the one or more codes, as described above with respect to block 1020 of FIG. 10.

At block 1230, the mobile device may obtain information indicating a data throughput between the mobile device and the base station. For example, the mobile device may determine the data throughput based on its data communication with the base station.

At block 1230, the mobile device may determine whether the code from the one or more codes is associated with a small cell based on both the signal strength information of the signal and the information indicating the data throughput between the mobile device and the base station. For example, a high data throughput between the base station and the mobile device in combination with a small RSSI of the RF signal from the base station may indicate that the base station is likely associated with a close-by small cell. As described above with respect to FIG. 10, the mobile device may then communicate with a crowdsourcing server to indicate that the base station is associated with a small cell, or that the code associated with the base station is associated with small cells. The crowdsourcing server may collect such information from multiple mobile devices, and use the information collected from the multiple mobile devices to cross-verify the accuracy of the information.

In some embodiments, a mobile device or a server may identify a small cell with or without using crowdsourced data. For example, in most circumstances, small cells may not share a same location area code or tracking area code with macro cells. Further, each small cell may only cover a small area, and there is usually no overlap between the coverage areas of two small cells. On the other hand, a macro cell generally covers a larger area and there might usually be overlap between the coverage areas of two or more macro cells. A mobile device may therefore identify small cells based on these characteristics. Additionally or alternatively, a server may identify small cells based on these characteristics using data collected by one or more mobile devices.

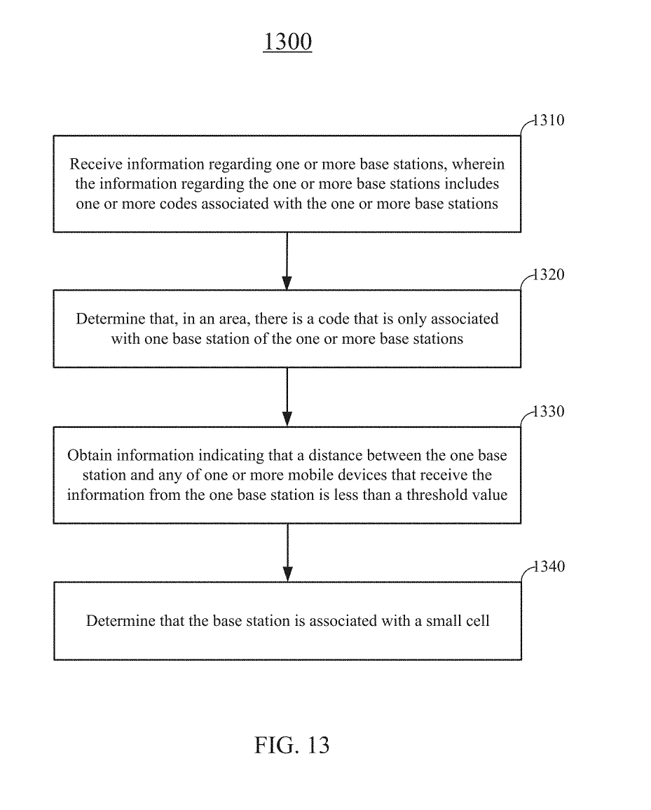

FIG. 13 is a flow chart 1300 illustrating an example method of identifying small cells based on a determination that only a single cell in an area is associated with a code, according to certain aspects of the present disclosure. At block 1310, a server, such as crowdsourcing server 230 and/or location assistance server 260 of FIG. 2, or a mobile device may receive information regarding one or more base stations from one or more mobile devices or servers, where the information regarding each of the one or more base stations includes a code, for example, an ID3 code such as a location area code or a tracking area code, of the cell associated with the base station. For example, a mobile device may travel within an area and receive information from one or more base stations and/or send the received information to a server. The information may also be collected by two or more mobile devices located in the area and receiving broadcast information from the one or more base stations.

At block 1320, the mobile device or the server may determine that, in an area, there is a location area code or a tracking area code that is associated with only a single base station. For example, a mobile device that travels in the area and receives broadcast information from base stations may determine the number of cells that share a same location area code or tracking area code. If there is one location area code or tracking area code that is associated with only one cell in the area, it is possible that the one cell may be a small cell, but further determination may be needed to confirm that the cell is a small cell.

At block 1330, the mobile device or the server may obtain information indicating that a distance between the base station and any of one or more mobile devices that receive the information from the base station is less than a threshold distance value, such as, for example, less than one (1) kilometer, five hundred (500) meters, or one hundred (100) meters, using, for example, an RTT or a TOF of a signal transmitted between the base station and the mobile device.

At block 1340, the mobile device or the server may determine that the base station is associated with a small cell based on the determination that there is one location area code or tracking area code that is associated with only one cell in the area, and that the distance between the base station of the one cell and any mobile device that receives information from the base station is less than a threshold distance value. The location area code or tracking area code associated with the base station may therefore be associated with small cells.

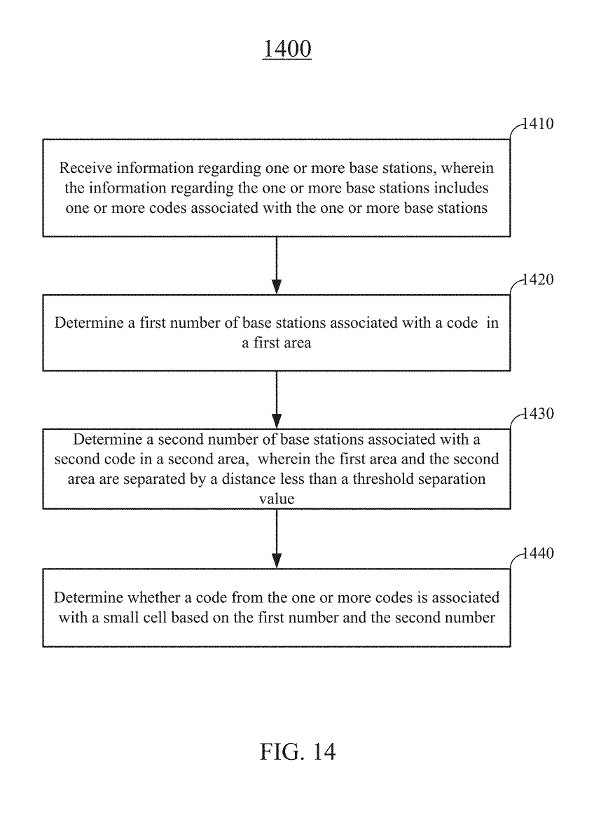

FIG. 14 is a flow chart 1400 illustrating an example method of identifying small cells based on a determination that a cell associated with a certain code is in close proximity to cells associated with a different code, according to certain aspects of the present disclosure. At block 1410, a server, such as crowdsourcing server 230 and/or location assistance server 260 of FIG. 2, or a mobile device may receive information regarding one or more base stations from one or more mobile devices or servers, where the information regarding each of the one or more base stations includes a code, for example, an ID3 code such as a location area code or a tracking area code, of the cell associated with the base station. For example, a mobile device may travel within an area and receive information from one or more base stations and/or send the received information to a server. The information may also be collected by two or more mobile devices traveling in the area and receiving broadcast information from base stations.

At block 1420, the mobile device or the server may determine a first number of base stations associated with a code in a first area. For example, a mobile device that travels in the area and receives broadcast information from base stations may determine the number of base stations associated with a same location area code or tracking area code. If there is one location area code or tracking area code that is associated with only one base station in the area, it is possible that the one base station may be associated with a small cell, but it is also possible that the one base station is associated with a macro cell and the mobile device is near the center of the macro cell. Therefore, further determination may be needed to confirm that the one base station is associated with a small cell.

At block 1430, the mobile device or the server may determine a second number of base stations associated with a second code in a second area, where the first area and the second area are separated by a distance less than a threshold separation value. For example, the mobile device may travel a short distance, such as, for example, one hundred (100) meters or less, from the first area to the second area, and detect two or more cells associated with a second location area code or tracking area code different from the first location area code or tracking area code. Alternatively, the mobile device may not travel at all such that the first area overlaps with the second area, for example, if the first area is fully within the second area. More generally, a first number of cells may be associated with the first location area code or tracking area code in the first area and a second number of network access points may be associated with the second location area code or tracking area code in the second area. If the first area and the second area are separated by a distance that is less than a threshold separation value or the first area is within the second area, and the number of cells in the first area is small, for example the number of cells in the first area is one, this suggests that there may be only one cell associated with the first location area code or tracking area code in the first area. This supports an inference that there is only one cell in the first area and makes less likely the possibility that the first area is large and that only one cell is being detected because other cells in the area are far away. This can help to confirm the inference made at block 1420 that the first cell is the only cell in the first area. This increases the confidence in a conclusion that the first cell is a small cell.

At block 1440, the mobile device or the server may determine whether a code from the one or more codes is associated with a small cell based on the first number and the second number determined at blocks 1420 and 1430. For example, if the first number is one, and the second number is more than one, the mobile device or the server may conclude that the first cell is a small cell and the first location area code or tracking area code is associated with small cells, because the first area is near the boundaries between two or more macro cells but only a single cell in the first area is associated with the first location area code or tracking area code. Furthermore, it is understood that at block 1440, the determination of whether the code is associated with the small cell being based on the first number and the second number implies that the determination is further based on the threshold separation value.

In some examples, a mobile device may determine the coverage area of a cell by traveling within an area near the cell. A crowdsourcing server may similarly determine the coverage area of a cell based on information collected by one or more mobile devices. If the coverage area of a cell is small, the cell may be a small cell, and the mobile device or the crowdsourcing server may determine that the ID3 of the cell is associated with small cells.

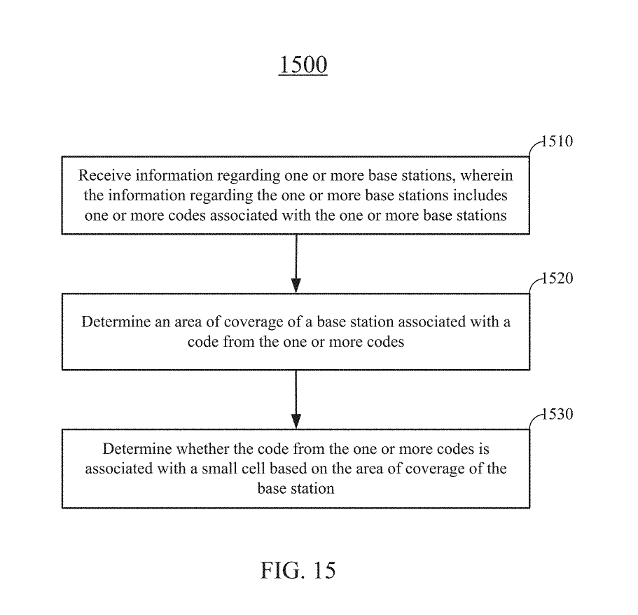

FIG. 15 is a flow chart 1500 illustrating an example method of identifying small cells based on a coverage area of a cell, according to certain aspects of the present disclosure. At block 1510, a server, such as crowdsourcing server 230 and/or location assistance server 260 of FIG. 2, or a mobile device may receive information regarding one or more base stations from one or more mobile devices or servers, where the information regarding each of the one or more base stations includes a code, for example, an ID3 code such as a location area code or a tracking area code, of the cell associated with the base station. For example, a mobile device may travel within an area and receive information from one or more base stations and may, for example, send the received information to a server. The information may also be collected by two or more mobile devices traveling in the area and receiving broadcast information from base stations.

At block 1520, the mobile device or a server may determine an area of coverage of a base station associated with a code from the one or more codes. Information related to the area of coverage of the base station may be collected by one or more mobile devices. For example, the mobile device may travel in the area, detect signals transmitted by the base station, and record the locations where a signal transmitted by the base station is detected. The information may also be collected by two or more mobile devices that are stationary or traveling in the area. The collected information may be sent to a crowdsourcing server, such as crowdsourcing server 230 and/or location assistance server 260 of FIG. 2. The mobile device or server may determine the area of coverage of the base station associated with the code based on, for example, the locations where signals transmitted by the base station could be detected by one or more mobile devices.

At block 1530, the mobile device or the server may determine whether the code from the one or more codes is associated with a small cell based on the area of coverage of the base station. For example, if the area of coverage of the base station associated with the code is below a threshold value, such as, for example, about ten (10) square kilometers (for example, less than eight (8) square kilometers corresponding to about a radius of coverage of about twenty five (25) meters), or about five (5) square kilometers, or about one (1) square kilometer, the base station may be associated with a small cell, and the code associated with the base station may be associated with small cells.

In various embodiments, techniques described above with respect to, for example, FIGS. 7, 8, 10, and 12-15, may be used alone or in any combination to more accurately identify small cells. For example, one or more of these techniques may be used to identify small cells based on various available information, and may be used to cross-check determinations made with different techniques based on different information. In other words, the method for identifying small cells may include receiving information associated with one or more base stations, where the information associated with the one or more base stations includes one or more codes associated with the one or more base stations; and determining whether a code from the one or more codes is associated with a small cell based on one or more selected from the list consisting of (1) a number of the one or more base stations associated with the code; (2) an aggregated area of coverage of the one or more base stations associated with the code; (3) both (a) a signal strength information of a signal received by a mobile device from a base station of the one or more base stations, where the base station is associated with the code, and (b) information indicating a distance between the mobile device and the base station; (4) the signal strength information of the signal received by the mobile device from the base station of the one or more base stations and information indicating a data throughput between the mobile device and the base station; (5) a first number of base stations associated with the code in a first area, and a second number of base stations associated with a second code in a second area, where the first area and the second area are separated by a distance less than a threshold separation value; and (6) an area of coverage of a base station of the one or more base stations associated with the code.

After it is determined that cells sharing a same ID3 (e.g., location area code or tracking area code) may include small cells or the ID3 is assigned to small cells, data associated with the cells sharing the ID3 may be selectively included or excluded from the assistance data based on user requirements. For example, in some circumstances, data associated with identified small cells may be excluded from the assistance data to be sent to a wireless device, such as a mobile device, for determining the location of the wireless device, such that the amount of assistance data sent to the wireless device may be reduced and more reliable assistance data may be sent to and saved on the wireless device for positioning.

In some examples, if the location information of a cell is unknown and it is determined that the ID3 of the cell is associated with small cells, a server or mobile device may be instructed to not use the location area information associated with the ID3, such as the center of the location area associated with the ID3, as the fallback location of the cell.

In some examples, the location of a small cell may be included in the assistance data for proximity positioning. Because the coverage area of a small cell is small, the location of the small cell may be used as the location of a mobile device communicating with (i.e., camping on) the small cell. For example, if a femtocell is determined to be located at 123 A Street, City B, State C, a mobile phone camping on the femtocell may be determined to be located at the same address.

In some examples, the location of a small cell may be used with other data in the assistance data, such as locations of WiFi access points and/or locations of macro cells, for hybrid positioning. For example, a mobile device may use the locations of a small cell base station, a WiFi access point, and a macro cell base station and the distances between the mobile device and each of the small cell base station, the WiFi access point, and the macro cell base station to determine its position using, for example, trilateration techniques.

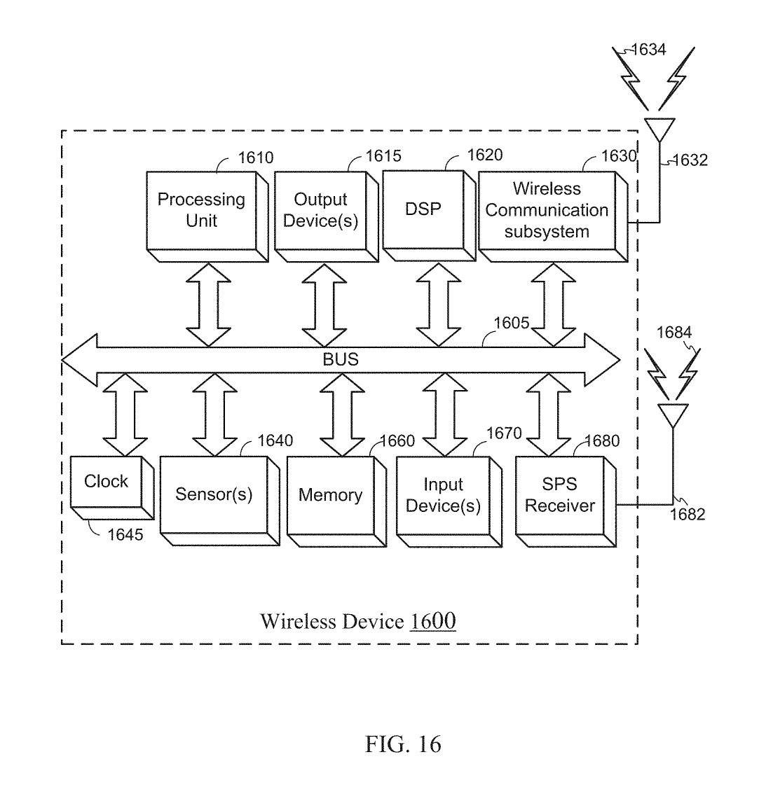

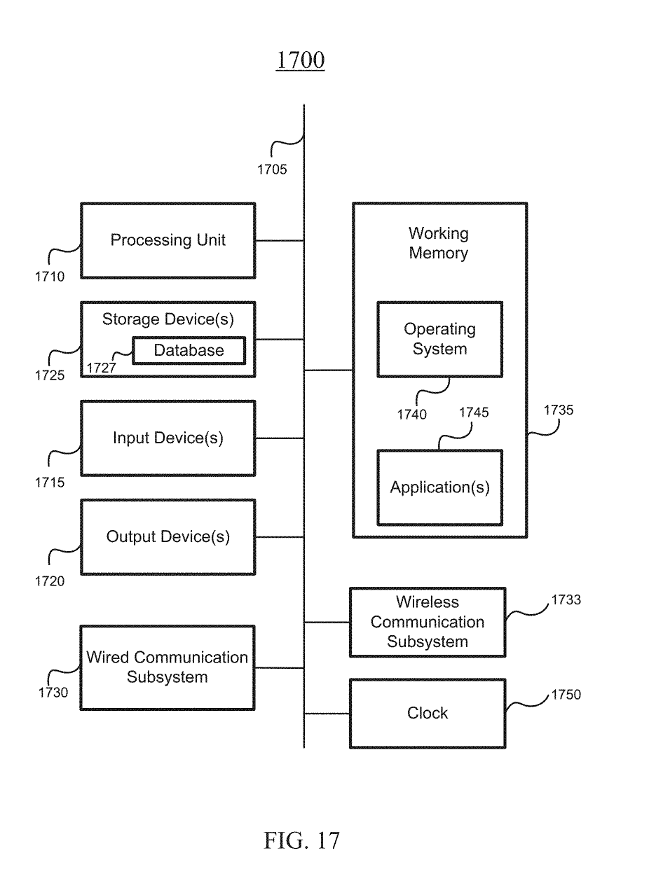

In various embodiments, means for receiving information associated with one or more base stations may include, but are not limited to, for example, mobile device 105 or server 160 of FIG. 1, mobile devices 270-1, 270-2, . . . , and 270-N or crowdsourcing server 230 and/or location assistance server 260 of FIG. 2, antenna 1632, wireless communication subsystem 1630, and bus 1605 as illustrated in FIG. 16 and described in detail below, or wireless communication subsystem 1733 and bus 1705 as illustrated in FIG. 17 and described in detail below.

In various embodiments, means for determining whether a location area code or a tracking area code is associated with a small cell may include, but are not limited to, for example, mobile device 105 or server 160 of FIG. 1, mobile devices 270-1, 270-2, . . . , and 270-N or crowdsourcing server 230 and/or location assistance server 260 of FIG. 2, processing unit 1610, memory 1660, bus 1605, and/or clock 1645 as illustrated in FIG. 16 and described in detail below, or processing unit 1710, working memory 1735, bus 1705, and/or storage devices 1725 or clock 1750 as illustrated in FIG. 17 and described in detail below.

In various embodiments, means for determining a location of a mobile device in communication with a base station associated with the location area code or tracking area code based on a location of the base station may include, but are not limited to, for example, mobile device 105 or server 160 of FIG. 1, mobile devices 270-1, 270-2, . . . , and 270-N or crowdsourcing server 230 and/or location assistance server 260 of FIG. 2, processing unit 1610, memory 1660, and bus 1605 as illustrated in FIG. 16 and described in detail below, or processing unit 1710, working memory 1735, bus 1705, and/or storage devices 1725 as illustrated in FIG. 17 and described in detail below.

It is noted that even though FIGS. 7, 8, 10, and 12-15 describe the operations as sequential processes, many of the operations can be performed in parallel or concurrently. In addition, the order of the operations may be rearranged. An operation may have additional steps not included in the figure. Some operations may be optional, and thus may be omitted in various embodiments. Some operations described in one block may be performed together with operations at another block. For example, some operations may be performed in parallel. Furthermore, embodiments of the methods may be implemented in hardware, software, firmware, middleware, microcode, hardware description languages, or any combination thereof.

FIG. 16 illustrates an embodiment of a wireless device 1600, which can be utilized as described herein above. For example, wireless device 1600 can be used as an access point, a mobile device, a base transceiver station, or a server as described in relation to the embodiments previously provided herein. It should be noted that FIG. 16 is meant only to provide a generalized illustration of various components, any or all of which may be utilized as appropriate. It can be noted that, in some instances, components illustrated by FIG. 16 can be localized to a single physical device and/or distributed among various networked devices, which may be disposed at different physical locations. In some embodiments, for example, wireless device 1600 can be a cellular telephone or other mobile electronic device. In some embodiments, wireless device 1600 may be a stationary device, such as an access point or a base transceiver station. As such, as previously indicated, components may vary from embodiment to embodiment.

Wireless device 1600 is shown comprising hardware elements that can be electrically coupled via a bus 1605 (or may otherwise be in communication, as appropriate). The hardware elements may include a processing unit(s) 1610 which can include without limitation one or more general-purpose processors, one or more special-purpose processors (such as digital signal processing (DSP) chips, graphics acceleration processors, application specific integrated circuits (ASICs), and/or the like), and/or other processing structure or means, which can be configured to perform one or more of the methods described herein. As shown in FIG. 16, some embodiments may have a separate DSP 1620, depending on desired functionality. Wireless device 1600 also can include one or more input devices 1670, which can include without limitation a touch screen, a touch pad, microphone, button(s), dial(s), switch(es), and/or the like; and one or more output devices 1615, which can include without limitation a display, light emitting diodes (LEDs), speakers, and/or the like.

Wireless device 1600 might also include a wireless communication subsystem 1630, which can include without limitation a modem, a network card, an infrared communication device, a wireless communication device, and/or a chipset (such as a Bluetooth device, an International Electrical and Electronics Engineers (IEEE) 802.11 device (e.g., a device utilizing one or more of the 802.11 standards described herein), an IEEE 802.15.4 device, a WiFi device, a WiMax device, cellular communication facilities, etc.), and/or the like. Wireless communication subsystem 1630 may permit data to be exchanged with a network, wireless access points, other computer systems, and/or any other electronic devices described herein, such as the configuration of FIG. 1. The communication can be carried out via one or more wireless communication antenna(s) 1632 that send and/or receive wireless signals 1634. In various embodiments, wireless communication subsystem 1630 may be used to measure the timing information and/or RSSI of a signal from an antenna for estimating a distance between wireless device 1600 and the antenna, based on, for example, the time of flight, round-trip time, or signal strength information as described above with respect to FIGS. 1, 10, and 12.

Depending on desired functionality, wireless communication subsystem 1630 can include separate transceivers to communicate with antennas of base transceiver stations and other wireless devices and access points as described above, which may include communicating with different data networks and/or network types, such as wireless wide-area networks (WWANs), wireless local area networks (WLANs), or wireless personal area networks (WPANs). A WWAN may be a network using any air interface technology, for example, a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000, W-CDMA, and so on. Cdma2000 includes IS-95, IS-2000, and/or IS-856 standards. A TDMA network may implement GSM, Digital Advanced Mobile Phone System (D-AMPS), or some other RATs. An OFDMA network may employ LTE, LTE Advanced, and so on. LTE, LTE Advanced, GSM, and W-CDMA are described in documents from 3GPP. Cdma2000 is described in documents from a consortium named “3rd Generation Partnership Project 2” (3GPP2). 3GPP and 3GPP2 documents are publicly available. A WLAN may be an IEEE 802.11x network. A WPAN may be a Bluetooth network, an IEEE 802.15x, or some other type of network. The techniques described herein may also be used for any combination of WWAN, WLAN and/or WPAN.

Wireless device 1600 may include a clock 1645 on bus 1605, which can generate a signal to synchronize various components on bus 1605. Clock 1645 may include an inductor-capacitor (LC) oscillator, a crystal oscillator, a ring oscillator, a digital clock generator such as a clock divider or clock multiplexer, a phase locked loop, or other clock generator. Clock 1645 may be synchronized (or substantially synchronized) with corresponding clocks on other wireless devices. Clock 1645 may be driven by wireless communication subsystem 1630, which may be used to synchronize clock 1645 of wireless device 1600 to one or more other devices. Clock 1645 may be used for timing measurement.

Wireless device 1600 can further include sensor(s) 1640. Such sensors can include, without limitation, one or more accelerometer(s), gyroscope(s), camera(s), magnetometer(s), altimeter(s), microphone(s), proximity sensor(s), light sensor(s), and the like. Some or all of sensor(s) 1640 can be utilized, among other things, for dead reckoning and/or other positioning methods. Such positioning methods may be used to determine a location of wireless device 1600, and may utilize and/or complement the RTT values obtained as described herein.

Embodiments of the wireless device 1600 may also include an SPS receiver 1680 capable of receiving signals 1684 from one or more SPS satellites using an SPS antenna 1682. Such positioning can be utilized to complement and/or incorporate the techniques for calculating RTT described herein. SPS receiver 1680 can extract a position of the wireless device 1600, using conventional techniques, from SPS satellite vehicles (SVs) of an SPS system, such as global navigation satellite system (GNSS) (e.g., Global Positioning System (GPS)), Galileo, Glonass, Compass, Quasi-Zenith Satellite System (QZSS) over Japan, Indian Regional Navigational Satellite System (IRNSS) over India, Beidou over China, and/or the like. Moreover, SPS receiver 1680 can use various augmentation systems (e.g., a Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein, an SPS system may include any combination of one or more global and/or regional navigation satellite systems and/or augmentation systems, and SPS signals may include SPS, SPS-like, and/or other signals associated with one or more such SPS systems.

Wireless device 1600 may further include and/or be in communication with a memory 1660. Memory 1660 may include any non-transitory storage device, and may include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

Memory 1660 of wireless device 1600 also can comprise software elements (not shown), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the functionality discussed above, such as the methods shown in FIGS. 7, 8, 10, and 12-15 might be implemented as code and/or instructions that can be stored or loaded in memory 1660 and be executed by wireless device 1600, a processing unit within wireless device 1600, and/or another device of a wireless system. In an aspect, such code and/or instructions can be used to configure and/or adapt a general purpose computer (or other device) to perform one or more operations in accordance with the described methods.

FIG. 17 illustrates components of a computing system 1700, according to one embodiment. For example, computing system 1700 can be used as an AP, a base transceiver station, or a server as described in relation to the embodiments previously provided herein, and may communicate in a wireless communication system with one or more mobile devices. In various embodiment, in contrast to the wireless device 1600 of FIG. 16 which may be mobile, computing system 1700 of FIG. 17 may, for example, be a stationary device (or set of devices). It should be noted that FIG. 17 is meant only to provide a generalized illustration of various components, any or all of which may be utilized as appropriate. Moreover, system elements may be implemented in a relatively separated or relatively more integrated manner.

Computing system 1700 is shown comprising hardware elements that can be electrically coupled via a bus 1705 (or may otherwise be in communication, as appropriate). The hardware elements may include a processing unit 1710, including without limitation one or more general-purpose processors and/or one or more special-purpose processors (such as digital signal processing chips, graphics acceleration processors, and/or the like), one or more input devices 1715, and one or more output devices 1720. Input device(s) 1715 can include without limitation camera(s), a touchscreen, a touch pad, microphone(s), a keyboard, a mouse, button(s), dial(s), switch(es), and/or the like. Output devices 1720 may include without limitation a display device, a printer, LEDs, speakers, and/or the like.

Computing system 1700 can also include a wired communication subsystem 1730 and wireless communication technologies managed and controlled by a wireless communication subsystem 1733. As such, wired communication subsystem 1730 and wireless communication subsystem 1733 can include, without limitation, a modem, a network interface (wireless, wired, both, or other combination thereof), an infrared communication device, a wireless communication device, and/or a chipset (such as a Bluetooth™ device, an IEEE 802.11 device (e.g., a device utilizing one or more of the IEEE 802.11 standards described herein), a WiFi device, a WiMax device, cellular communication facilities, etc.), and/or the like. Subcomponents of the network interface may vary, depending on the type of computing system 1700 (e.g., mobile phone, personal computer, etc.). Wired communication subsystem 1730 and wireless communication subsystem 1733 may include one or more input and/or output communication interfaces to permit data to be exchanged with a data network, other computer systems, and/or any other devices described herein. Moreover, wired communication subsystem 1730 and/or wireless communication subsystem 1733 may permit computing system 1700 to determine RTT via uplink multiple-input multiple-output (MIMO) processes.

Similar to wireless device 1600 of FIG. 16, computing system 1700 of FIG. 17 may include a clock 1750 on bus 1705, which can generate a signal to synchronize the various components on bus 1705. Clock 1750 may include an LC oscillator, a crystal oscillator, a ring oscillator, a digital clock generator such as a clock divider or clock multiplexer, a phase locked loop, or other clock generator. Clock 1750 may be synchronized (or substantially synchronized) with corresponding clocks on other wireless devices while performing the techniques described herein. Clock 1750 may be driven by wireless communication subsystem 1733, which may be used to synchronize clock 1750 of computing system 1700 to one or more other devices. Clock 1750 may be used for timing measurement.

Computing system 1700 may further include (and/or be in communication with) one or more non-transitory storage devices 1725, which can comprise, without limitation, local and/or network accessible storage, and/or can include, without limitation, a disk drive, a drive array, an optical storage device, a solid-state storage device, such as a RAM and/or a ROM, which can be programmable, flash-updateable and/or the like. Such storage devices may be configured to implement any appropriate data stores, including without limitation, various file systems, database structures, and/or the like. For instance, storage device(s) 1725 may include a database 1727 (or other data structure) configured to store information regarding one or more cells as described in embodiments herein, which may be provided to APs and/or other devices via wired communication subsystem 1730 or wireless communication subsystem 1733.

In many embodiments, computing system 1700 may further comprise a working memory 1735, which can include a RAM or ROM device, as described above. Software elements, shown as being currently located within working memory 1735, can include an operating system 1740, device drivers, executable libraries, and/or other code, such as one or more application programs 1745, which may comprise software programs provided by various embodiments, and/or may be designed to implement methods, and/or configure systems, provided by other embodiments, as described herein, such as some or all of the methods described in relation to FIGS. 7, 8, 10, and 12-15. Merely by way of example, one or more procedures described with respect to the method(s) discussed above might be implemented as code and/or instructions executable by a computer (and/or a processor within a computer). In an aspect, such code and/or instructions can be used to configure and/or adapt a general purpose computer (or other device) to perform one or more operations in accordance with the described methods.

A set of these instructions and/or code might be stored on a non-transitory computer-readable storage medium, such as non-transitory storage device(s) 1725 described above. In some cases, the storage medium might be incorporated within a computer system, such as computing system 1700. In other embodiments, the storage medium might be separate from a computer system (e.g., a removable medium, such as a flash drive), and/or provided in an installation package, such that the storage medium can be used to program, configure, and/or adapt a general purpose computer with the instructions/code stored thereon. These instructions might take the form of executable code, which is executable by computing system 1700 and/or might take the form of source and/or installable code, which, upon compilation and/or installation on computing system 1700 (e.g., using any of a variety of generally available compilers, installation programs, compression/decompression utilities, etc.), then takes the form of executable code.

It will be apparent to those skilled in the art that variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The terms “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, BC, AC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, information, data, values, elements, symbols, characters, variables, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Wireless communication techniques described herein may be in connection with various wireless communications networks such as a WWAN, a WLAN, a WPAN, and so on. The term “network” and “system” may be used interchangeably herein. A WWAN may be a CDMA network, a TDMA network, an FDMA network, an OFDMA network, an SC-FDMA network, or any combination of the above networks, and so on. For example, a WLAN may comprise an IEEE 802.11x network, and a WPAN may comprise a Bluetooth network, an IEEE 802.15x. Wireless communication implementations described herein may also be used in connection with any combination of WWAN, WLAN or WPAN.

In another aspect, as previously mentioned, a wireless transmitter or access point may comprise a cellular transceiver device, utilized to extend cellular telephone service into a business or home. In such an implementation, one or more mobile devices may communicate with a cellular transceiver device via a CDMA cellular communication protocol, for example.

Techniques described herein may be used with an SPS that includes any one of several GNSS and/or combinations of GNSS. Furthermore, such techniques may be used with positioning systems that utilize terrestrial transmitters acting as “pseudolites,” or a combination of SVs and such terrestrial transmitters. Terrestrial transmitters may, for example, include ground-based transmitters that broadcast a pseudo noise (PN) code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV,” as used herein, is intended to include terrestrial transmitters acting as pseudolites, equivalents of pseudolites, and possibly others. The terms “SPS signals” and/or “SV signals,” as used herein, are intended to include SPS-like signals from terrestrial transmitters, including terrestrial transmitters acting as pseudolites or equivalents of pseudolites.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

For an implementation involving firmware and/or software, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable storage medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, electrically erasable programmable read-only memory (EEPROM), compact disc read-only memory (CD-ROM) or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer-readable storage medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time, the transmission media included in the communication apparatus may include a second portion of the information to perform the disclosed functions.

What is claimed is:

1. A method comprising:
receiving information associated with one or more base stations, wherein the information associated with the one or more base stations includes one or more codes associated with the one or more base stations;
determining whether a code from the one or more codes is associated with a small cell based on at least one of:
a number of the one or more base stations associated with the code;
an aggregated area of coverage of the one or more base stations associated with the code;
both (a) a signal strength information of a signal, the signal received by a mobile device from a base station of the one or more base stations, wherein the base station is associated with the code, and (b) information indicating a distance between the mobile device and the base station;
the signal strength information of the signal received by the mobile device from the base station of the one or more base stations and information indicating a data throughput between the mobile device and the base station;
a first number of base stations associated with the code in a first area, and a second number of base stations associated with a second code in a second area, wherein the first area and the second area are separated by a distance less than a threshold separation value; or
an area of coverage of a base station of the one or more base stations associated with the code.

2. The method of claim 1, wherein determining whether the code is associated with the small cell is at least based on the number of the one or more base stations associated with the code, and wherein the number of the one or more base stations associated with the code is greater than one thousand.

3. The method of claim 1, wherein determining whether the code is associated with the small cell is at least based on the aggregated area of coverage of the one or more base stations associated with the code, and wherein the aggregated area of coverage of the one or more base stations associated with the code is greater than one thousand square kilometers.

4. The method of claim 1, wherein:
the signal strength information includes a received signal strength indicator (RSSI); and
the information indicating the distance between the mobile device and the base station includes at least one of a time of flight (TOF), a time of arrival (TOA), or a round trip time (RTT) of the signal.

5. The method of claim 4, wherein determining whether the code is associated with the small cell is at least based on both the signal strength information of the signal and the information indicating the distance between the mobile device and the base station, and wherein the RSSI is below a threshold power level and the distance between the mobile device and the base station is less than a threshold distance value.

6. The method of claim 1, wherein determining whether the code is associated with the small cell is at least based on the signal strength information of the signal received by the mobile device from the base station and the information indicating the data throughput between the mobile device and the base station, and wherein the signal strength information indicates a signal strength below a threshold power level and the data throughput is greater than a threshold data rate value.

7. The method of claim 1, wherein determining whether the code is associated with the small cell is at least based on the first number of base stations associated with the code in the first area and the second number of base stations associated with the second code in the second area, and wherein the first number is one and the second number is greater than one.

8. The method of claim 7, wherein the threshold separation value is 100 meters.

9. The method of claim 1, wherein determining whether the code is associated with the small cell is at least based on the area of coverage of the base station of the one or more base stations associated with the code, and wherein the area of coverage of the base station is less than one square kilometer.

10. The method of claim 1, further comprising:
based on determining that the code is associated with the small cell, sending assistance data to a wireless device, wherein data associated with base stations associated with the code is excluded from the assistance data to be sent to the wireless device.

11. The method of claim 1, further comprising:
based on determining that the code is associated with the small cell, determining that a location of a second mobile device in communication with a second base station associated with the code is a location of the second base station.

12. A system comprising:
a memory comprising machine-readable instructions stored thereon; and
a processing unit communicatively coupled to the memory and configured to execute the machine-readable instructions to identify a small cell by:
receiving information associated with one or more base stations, wherein the information associated with the one or more base stations includes one or more codes associated with the one or more base stations;
determining whether a code from the one or more codes is associated with a small cell based on at least one of:
a number of the one or more base stations associated with the code;
an aggregated area of coverage of the one or more base stations associated with the code;
both (a) a signal strength information of a signal, the signal received by a mobile device from a base station of the one or more base stations, wherein the base station is associated with the code, and (b) information indicating a distance between the mobile device and the base station;
the signal strength information of the signal received by the mobile device from the base station of the one or more base stations, and information indicating a data throughput between the mobile device and the base station;
a first number of base stations associated with the code in a first area, and a second number of base stations associated with a second code in a second area, wherein the first area and the second area are separated by a distance less than a threshold separation value; or
an area of coverage of a base station of the one or more base stations associated with the code.

13. The system of claim 12, wherein determining whether the code is associated with the small cell is at least based on the number of the one or more base stations associated with the code, and wherein the number of the one or more base stations associated with the code is greater than one thousand.

14. The system of claim 12, wherein determining whether the code is associated with the small cell is at least based on the aggregated area of coverage of the one or more base stations associated with the code, and wherein the aggregated area of coverage of the one or more base stations associated with the code is greater than one thousand square kilometers.

15. The system of claim 12, wherein:
the signal strength information includes a received signal strength indicator (RSSI); and
the information indicating the distance between the mobile device and the base station includes at least one of a time of flight (TOF), a time of arrival (TOA), or a round trip time (RTT) of the signal.

16. The system of claim 12, wherein determining whether the code is associated with the small cell is at least based on both the signal strength information of the signal and the information indicating the distance between the mobile device and the base station, and wherein the signal strength information of the signal indicates a signal strength below a threshold power level and the distance between the mobile device and the base station is less than a threshold distance value.

17. The system of claim 12, wherein determining whether the code is associated with the small cell is at least based on the signal strength information of the signal received by the mobile device from the base station and the information indicating the data throughput between the mobile device and the base station, and wherein the signal strength information indicates a signal strength below a threshold power level and the data throughput is greater than a threshold data rate value.

18. The system of claim 12, wherein determining whether the code is associated with the small cell is at least based on the first number of base stations associated with the code in the first area and the second number of base stations associated with the second code in the second area, and wherein the first number is one and the second number is greater than one.

19. The system of claim 12, wherein determining whether the code is associated with the small cell is at least based on the area of coverage of the base station of the one or more base stations associated with the code, and wherein the area of coverage of the base station is less than one square kilometer.

20. The system of claim 12, wherein the processing unit is further configured to execute the machine-readable instructions to:
based on determining that the code is associated with the small cell, send assistance data to a wireless device, wherein data associated with base stations associated with the code is excluded from the assistance data to be sent to the wireless device.

21. The system of claim 12, wherein the processing unit is further configured to execute the machine-readable instructions to:
based on determining that the code is associated with the small cell, determine that a location of a second mobile device in communication with a second base station associated with the code is a location of the second base station.

22. A non-transitory computer-readable storage medium comprising machine-readable instructions stored thereon that, when executed by one or more processing units, cause the one or more processing units to identify a small cell by:
receiving information associated with one or more base stations, wherein the information associated with the one or more base stations includes one or more codes associated with the one or more base stations;
determining whether a code from the one or more codes is associated with the small cell based on at least one of:
a number of the one or more base stations associated with the code;
an aggregated area of coverage of the one or more base stations associated with the code;
both (a) a signal strength information of a signal, the signal received by a mobile device from a base station of the one or more base stations, wherein the base station is associated with code, and (b) information indicating a distance between the mobile device and the base station;
the signal strength information of the signal received by the mobile device from the base station of the one or more base stations, and information indicating a data throughput between the mobile device and the base station;
a first number of base stations associated with the code in a first area, and a second number of base stations associated with a second code in a second area, wherein the first area and the second area are separated by a distance less than a threshold separation value; or
an area of coverage of a base station of the one or more base stations associated with the code.

23. The non-transitory computer-readable storage medium of claim 22, wherein determining whether the code is associated with the small cell is at least based on the number of the one or more base stations associated with the code, and wherein the number of the one or more base stations associated with the location area code or the tracking area code is greater than one thousand.

24. The non-transitory computer-readable storage medium of claim 22, wherein determining whether the code is associated with the small cell is at least based on both the signal strength information of the signal and the information indicating the distance between the mobile device and the base station, and wherein the signal strength information of the signal indicates a signal strength below a threshold power level and the distance between the mobile device and the base station is less than a threshold distance value.

25. The non-transitory computer-readable storage medium of claim 22, wherein determining whether the code is associated with the small cell is at least based on the signal strength information of the signal received by the mobile device from the base station and the information indicating the data throughput between the mobile device and the base station, and wherein the signal strength information indicates a signal strength below a threshold power level and the data throughput is greater than a threshold data rate value.

26. The non-transitory computer-readable storage medium of claim 22, wherein the machine-readable instructions, when executed by the one or more processing units, further cause the one or more processing units to:
based on determining that the code is associated with the small cell, send assistance data to a wireless device, wherein data associated with base stations associated with the code is excluded from the assistance data to be sent to the wireless device.

27. The non-transitory computer-readable storage medium of claim 22, wherein the machine-readable instructions, when executed by the one or more processing units, further cause the one or more processing units to:
based on determining that the code is associated with the small cell, determine that a location of a second mobile device in communication with a second base station associated with the code is a location of the second base station.

28. An apparatus comprising:
means for receiving information associated with one or more base stations, wherein the information associated with the one or more base stations includes one or more codes associated with the one or more base stations; and
means for determining whether a code from the one or more codes is associated with a small cell based on at least one of:
a number of the one or more base stations associated with the code;
an aggregated area of coverage of the one or more base stations associated with the code;
both (a) a signal strength information of a signal, the signal received by a mobile device from a base station of the one or more base stations, wherein the base station is associated with the location area code or the tracking area code, and (b) information indicating a distance between the mobile device and the base station;
the signal strength information of the signal received by the mobile device from the base station of the one or more base stations, and information indicating a data throughput between the mobile device and the base station;
a first number of base stations associated with the code in a first area, and a second number of base stations associated with a second code in a second area, wherein the first area and the second area are separated by a distance less than a threshold separation value; or
an area of coverage of a base station of the one or more base stations associated with the code.

29. The apparatus of claim 28, wherein:
the signal strength information includes a received signal strength indicator (RSSI); and
the information indicating the distance between the mobile device and the base station includes at least one of a time of flight (TOF), a time of arrival (TOA), or a round trip time (RTT) of the signal.

30. The apparatus of claim 28, further comprising:
means for, based on determining that the code is associated with the small cell, determining a location of a second mobile device in communication with a second base station associated with the code based on a location of the second base station.
